(19) United States
(12) Patent Application Publication
(10) Pub. No.: US 2025/0175827 A1
(43) Pub. Date: May 29, 2025

(54) METHOD AND APPARATUS FOR MOBILITY OPTIMIZATION IN WIRELESS COMMUNICATION SYSTEM

(71) Applicant: SAMSUNG ELECTRONICS CO., LTD., Suwon-si (KR)

(72) Inventors: Fuyuan LI, Beijing (CN); Hong WANG, Beijing (CN); Lixiang XU, Beijing (CN); Weiwei WANG, Beijing (CN); Bin WANG, Beijing (CN); Heechul JUNG, Suwon-si (KR)

(21) Appl. No.: 18/963,002

(22) Filed: Nov. 27, 2024

(30) Foreign Application Priority Data
Nov. 27, 2023 (CN) 202311595747.1

(51) Int. Cl. H04W 24/08; H04B 7/06; H04W 24/02

(52) U.S. Cl. CPC H04W 24/08; H04B 7/0626; H04W 24/02

(57) ABSTRACT

The disclosure relates to a 5G or 6G communication system for supporting a higher data transmission rate. A method and apparatus for mobility optimization in a wireless communication system are disclosed. According to an exemplary embodiment, a method performed by a first node in a wireless communication system comprises: receiving a first message comprising low layer triggered mobility (LTM) failure report information related to a user equipment (UE); and updating, based on the LTM failure report information and an LTM configuration related to mobility of the UE, an LTM configuration and/or triggering strategy related to the mobility of the UE.

### CROSS-REFERENCE TO RELATED APPLICATION

This application is based on and claims priority under 35 U.S.C. § 119 to Chinese Patent Application No. 202311595747.1 filed on Nov. 27, 2023, in the Chinese Intellectual Property Office, the disclosure of which is incorporated by reference herein in its entirety.

### BACKGROUND

### 1. Field

The present disclosure relates to the wireless communication technology, and specifically to a method and apparatus for mobility optimization in a wireless communication system.

### 2. Description of Related Art

Fifth generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service-based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and artificial intelligence (AI) from the design stage and internalizing end-to-end AI support functions, and next-generation distributed computing technology for implementing services at levels of complexity exceeding the limit of UE operation capability by utilizing ultra-high-performance communication and computing resources.

In order to meet an increasing demand for wireless data communication services since a deployment of 4G communication system, efforts have been made to develop an improved 5G or pre-5G communication system. Therefore, the 5G or pre-5G communication system is also called “beyond 4G network” or “post LTE system.”

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

In order to reduce the interrupt latency of business service of a UE in a mobility procedure, Rel-18 is currently formulating specifications for L1/L2 triggered mobility (LTM). The main process is that, based on the layer 1 (L1) measurement report reported by the UE, the gNB-DU decides a target cell and transmits a mobility command to the UE. Compared with the previous handover procedure performed based on an L3 measurement report, since the L3 measurement report is obtained based on the reprocessing such as linear averaging on the L1 measurement, the handover based on the L1 measurement report can have a faster mobility command, and the UE can receive this command more quickly through the L2 MAC CE of the gNB-DU. In addition, for the access process of the UE, a non-traditional random access channel (RACH) access (i.e., rach-less) procedure can be applied, thereby further reducing the interrupt latency of business service of the UE in the mobility procedure.

### SUMMARY

According to an aspect of the present disclosure, a method performed by a first node in a wireless communication system comprises: receiving a first message comprising low layer triggered mobility (LTM) failure report information related to a user equipment (UE); and updating, based on the LTM failure report information and an LTM configuration related to mobility of the UE, an LTM configuration and/or triggering strategy related to the mobility of the UE.

In an exemplary embodiment, the LTM failure report information may comprise at least one of an LTM failure type, a cell global identifier (CGI) of a source cell, the CGI of a target cell, the CGI of a re-establishment cell, the CGI of a recovery cell, a cell radio network temporary identifier (C-RNTI) of the source cell, the C-RNTI of a target cell, the C-RNTI of a last serving cell, a UE RLF report container and a TA invalidation indication that are associated with the UE; or the LTM failure report information may be associated with a secondary cell group (SCG) failure, and comprise at least one of the LTM failure type, a source primary secondary cell (PSCell) CGI, the CGI of a target PSCell, the CGI of a suitable PSCell, the C-RNTI of a source PSCell, the C-RNTI of a target PSCell, the C-RNTI of a last serving PSCell, an SCG failure report container and the TA invalidation indication that are associated with the UE.

In an exemplary embodiment, the first message may be an LTM failure report message, an LTM PSCell failure report message, an access and mobility indication (AAMI) message, or an Xn application protocol (Xnap) handover report message.

In an exemplary embodiment, the LTM configuration related to the mobility of the UE is contained in the LTM failure report information, and the LTM configuration comprises at least one of: an LTM candidate cell list, an LTM candidate cell ID, an LTM source cell ID, an LTM channel state information (CSI) resource configuration, and an LTM CSI report configuration.

In an exemplary embodiment, the method performed by the first node may further comprise: receiving a second message related to UE context release, the second message comprising an LTM configuration kept indicator; and releasing an LTM configuration unrelated to the mobility of the UE and keeping the LTM configuration related to the mobility of the UE according to the second message. Here, the LTM configuration related to the mobility of the UE comprises at least one of: an LTM candidate cell list, an LTM candidate cell ID, an LTM source cell ID, an LTM CSI resource configuration, and an LTM CSI report configuration.

In an exemplary embodiment, the second message may be an F1 application protocol (F1AP) UE CONTEXT RELEASE COMMAND message, a UE context modification request message, or an Xnap UE context release message.

In an exemplary embodiment, the method performed by the first node may further comprise: transmitting a message comprising the LTM configuration related to the mobility of the UE, the LTM configuration comprising at least one of: an LTM candidate cell list, an LTM candidate cell ID, an LTM source cell ID, an LTM CSI resource configuration, and an LTM CSI report configuration. Here, a previously transmitted LTM configuration is contained in the received first message.

According to an aspect of the present disclosure, a method performed by a user equipment (UE) in a wireless communication system comprises: transmitting a message comprising radio link failure (RLF) report information, the RLF report information being used to generate low layer triggered mobility (LTM) failure report information related to mobility of the UE; and executing an LTM procedure based on an LTM configuration updated using the LTM failure report information and an LTM configuration related to the mobility of the UE.

In an exemplary embodiment, the RLF report information may comprise at least one of the LTM configuration related to the mobility of the UE or LTM failure-related information. Here, the LTM configuration comprises at least one of: an LTM candidate cell list, an LTM candidate cell ID, an LTM source cell ID, an LTM channel state information (CSI) resource configuration, and an LTM CSI report configuration. Here, the LTM failure-related information may comprise at least one of: source cell information, target cell information, neighbor cell information, LTM candidate cell information, LTM cell information, last handover type information, information indicating a random access channel-based (rach)-based access failure or a rach-less access failure, and information on the rach-less access failure. Optionally, the LTM failure-related information may be associated with a secondary cell group (SCG) failure, and comprise at least one of: an LTM failure type, source primary secondary cell (PSCell) information, target PSCell information, neighbor PSCell information, an LTM candidate PSCell list, an LTM PSCell identifier, the information indicating the rach-based access failure or rach-less access failure, and the information on the rach-less access failure.

In an exemplary embodiment, the LTM configuration related to the mobility of the UE is contained in the LTM failure report information. Here, the LTM configuration may comprise at least one of: an LTM candidate cell list, an LTM candidate cell ID, an LTM source cell ID, an LTM CSI resource configuration, and an LTM CSI report configuration.

In an exemplary embodiment, the LTM failure report information may comprise at least one of an LTM failure type, a cell global identifier (CGI) of a source cell, the CGI of a target cell, the CGI of a re-establishment cell, the CGI of a recovery cell, a cell radio network temporary identifier (C-RNTI) of the source cell, the C-RNTI of a target cell, the C-RNTI of a last serving cell, a UE RLF report container and a TA invalidation indication that are associated with the UE. Optionally, the LTM failure report information may be associated with a secondary cell group (SCG) failure, and comprise at least one of the LTM failure type, a source primary secondary cell (PSCell) CGI, the CGI of a target PSCell, the CGI of a suitable PSCell, the C-RNTI of a source PSCell C-RNTI, the C-RNTI of a target PSCell, the C-RNTI of a last serving PSCell, an SCG failure report container and the TA invalidation indication that are associated with the UE.

In an exemplary embodiment, the information on the rach-less access failure may comprise at least one of: information on no reception of a dynamic grant, information on no reception of uplink scheduling of a new transmission, or information on an invalid TA value and/or actual TA value.

In an exemplary embodiment, the method performed by the UE may further comprise: receiving, during a rach-less access, an indication of a fallback to a rach-based access; and terminating the rach-less access and performing the rach-based access, in response to the received indication.

In an exemplary embodiment, the rach-less access failure may be determined based on a timer value configured for the rach-less access, or based on a timer value configured for the rach-based access and an offset value configured for the rach-less access.

In an exemplary embodiment, at least one of the source cell information, the target cell information, the neighbor cell information, the LTM candidate cell information, the LTM cell information, the source PSCell information, the target PSCell information and the neighbor PSCell information may comprise the CGI of a cell and L1 measurement result of a corresponding cell.

According to an aspect of the present disclosure, a method performed by a second node in a wireless communication system comprises: generating low layer triggered mobility (LTM) failure report information according to radio link failure (RLF) report information of a user equipment (UE); and transmitting a first message comprising the LTM failure report information. Here, the LTM failure report information and an LTM configuration related to mobility of the UE are used to update an LTM configuration and/or triggering strategy related to the mobility of the UE.

In an exemplary embodiment, the LTM failure report information may comprise at least one of: an LTM failure type, a cell global identifier (CGI) of a source cell, the CGI of a target cell, the CGI of a re-establishment cell, the CGI of a recovery cell, a cell radio network temporary identifier (C-RNTI) of the source cell, the C-RNTI of a target cell, the C-RNTI of a last serving cell, a UE RLF report container and a TA invalidation indication that are associated with the UE; or the LTM failure report information may be associated with a secondary cell group (SCG) failure, and comprise at least one of: the LTM failure type, a source primary secondary cell (PSCell) CGI, the CGI of a target PSCell, the CGI of a suitable PSCell, the C-RNTI of a source PSCell, the C-RNTI of a target PSCell, the C-RNTI of a last serving PSCell, an SCG failure report container and the TA invalidation indication that are associated with the UE.

In an exemplary embodiment, the first message may refer to an LTM failure report message, an LTM PSCell failure report message, an access and mobility indication (AAMI) message, or an Xn application protocol (Xnap) handover report message.

In an exemplary embodiment, the method performed by the second node may further comprise: receiving a message comprising the RLF report information from the UE, the RLF report information comprising at least one of the LTM configuration related to the mobility of the UE or LTM failure-related information. Here, the LTM configuration may comprise at least one of: an LTM candidate cell list, an LTM candidate cell ID, an LTM source cell ID, an LTM channel state information (CSI) resource configuration, and an LTM CSI report configuration. Here, the LTM failure-related information may comprise at least one of: source cell information, target cell information, neighbor cell information, LTM candidate cell information, LTM cell information, last handover type information, information indicating a random access channel (rach)-based access failure or a rach-less access failure, and information on the rach-less access failure. Optionally, the LTM failure-related information may be associated with a secondary cell group (SCG) failure, and comprise at least one of: an LTM failure type, source primary secondary cell (PSCell) information, target PSCell information, neighbor PSCell information, an LTM candidate PSCell list, an LTM PSCell identifier, the information indicating the rach-based access failure or rach-less access failure, and the information on the rach-less access failure.

In an exemplary embodiment, the LTM failure report information may comprise the LTM configuration related to the mobility of the UE, and the LTM configuration comprises at least one of: an LTM candidate cell list, an LTM candidate cell ID, an LTM source cell ID, an LTM CSI resource configuration, and an LTM CSI report configuration.

In an exemplary embodiment, the method performed by the second node may further comprise: transmitting, to a first node, a second message related to UE context release, the second message comprising an LTM configuration kept indicator. Here, the LTM configuration kept indicator may be used to indicate that the first node keeps the LTM configuration related to the mobility of the UE while releasing an LTM configuration unrelated to the mobility of the UE, and the LTM configuration related to the mobility of the UE may comprise at least one of: an LTM candidate cell list, an LTM candidate cell ID, an LTM source cell ID, an LTM CSI resource configuration, and an LTM CSI report configuration.

In an exemplary embodiment, the second message may refer to an F1 application protocol (F1AP) UE context release command message, a UE context modification request message, or an Xnap UE context release message.

In an exemplary embodiment, the information on the rach-less access failure may comprise at least one of: information on no reception of a dynamic grant, information on no reception of uplink scheduling of a new transmission, and information on an invalid TA value and/or actual TA value.

In an exemplary embodiment, the method performed by the second node may further comprise: receiving and storing a message of the LTM configuration related to the mobility of the UE, the LTM configuration comprising at least one of: an LTM candidate cell list, an LTM candidate cell ID, an LTM source cell ID, an LTM CSI resource configuration, and an LTM CSI report configuration. Here, a previously received and stored LTM configuration is contained in the first message to be transmitted.

In an exemplary embodiment, the message of the LTM configuration related to the mobility of the UE may refer to a sequence number SN status transfer message.

In an exemplary embodiment, the method performed by the second node may further comprise: determining that the UE may have a rach-less access failure; and transmitting an indication of a fallback to a rach-based access to the UE.

In an exemplary embodiment, the determining that the UE may have a rach-less access failure may comprise: determining that the UE may have the rach-less access failure on the basis that the TA value of the target cell configured for a rach-less access is invalid or a TAT timer expires.

According to other aspects of the present disclosure, the first node, the UE and the second node that perform the above methods are further disclosed.

According to another aspect of the present disclosure, a computer readable storage medium is further disclosed. The computer readable storage medium stores a computer executable instruction. When the computer executable instruction is executed by a processor, the processor performs the above methods performed by the first node, the UE or the second node.

According to the technical solution of the present disclosure, by updating the LTM configuration and/or triggering policy related to the mobility of the UE according to the LTM failure report information related to the UE, similar failures are avoided in the subsequent LTM procedure, thereby making the LTM procedure have a higher handover success rate.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an exemplary system architecture evolved according to exemplary embodiments of the present disclosure;

FIG. 2 illustrates an exemplary system architecture according to exemplary embodiments of the present disclosure;

FIG. 3 illustrates a flowchart of an LTM procedure according to exemplary embodiments of the present disclosure;

FIGS. 4A and 4B illustrate flowcharts of an LTM failure analysis and report in an LTM procedure according to an exemplary embodiment of the present disclosure;

FIGS. 5A, 5B and 5C illustrate flowcharts of a scheme of storing and transmitting an LTM configuration in an LTM procedure according to an exemplary embodiment of the present disclosure;

FIGS. 6A, 6B and 6C illustrate flowcharts of a scheme of storing and transmitting an LTM configuration in an LTM procedure according to an exemplary embodiment of the present disclosure;

FIG. 7 illustrates a rach-less access procedure in an LTM procedure according to an exemplary embodiment of the present disclosure;

FIG. 8A illustrates a flowchart of an LTM procedure in a dual connection scenario according to an exemplary embodiment of the present disclosure;

FIGS. 8B and 8C illustrate flowcharts of an LTM failure analysis and report in the LTM procedure in the dual connection scenario of FIG. 8A according to exemplary embodiment of the present disclosure;

FIGS. 8D, 8E and 8F illustrate flowcharts of a scheme of storing and transmitting an LTM configuration in the LTM procedure in the dual connection scenario of FIG. 8A according to exemplary embodiment of the present disclosure;

FIG. 9 illustrates a method performed by a first node according to an exemplary embodiment of the present disclosure;

FIG. 10 illustrates a method performed by a UE according to an exemplary embodiment of the present disclosure;

FIG. 11 illustrates a method performed by a second node according to an exemplary embodiment of the present disclosure; and

FIG. 12 illustrates an exemplary structure of each node according to exemplary embodiment of the present disclosure.

### DETAILED DESCRIPTION OF EMBODIMENTS

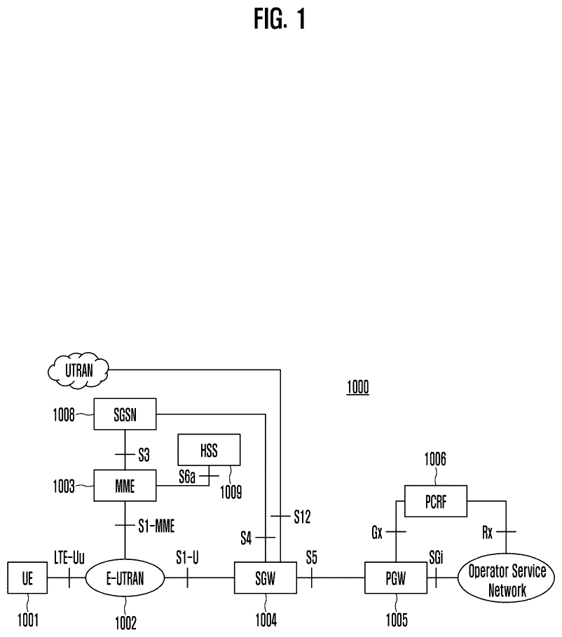

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Figures discussed below and various embodiments for describing the principles of the present disclosure in this patent document are only for illustration and should not be interpreted as limiting the scope of the disclosure in any way. Those skilled in the art will understand that the principles of the present disclosure can be implemented in any suitably arranged system or device.

FIG. 1 illustrate an exemplary system architecture 1000 of system architecture evolution (SAE) according to exemplary embodiments of the present disclosure. A user equipment (UE) 1001 is a terminal device for receiving data. An evolved universal terrestrial radio access network (E-UTRAN) 1002 is a radio access network, which includes a macro base station (eNodeB/NodeB) that provides UE with interfaces to access the radio network. A mobility management entity (MME) 1003 is responsible for managing mobility context, session context and security information of the UE. A serving gateway (SGW) 1004 mainly provides functions of user plane, and the MME 1003 and the SGW 1004 may be in the same physical entity. A packet data network gateway (PGW) 1005 is responsible for functions of charging, lawful interception, etc., and may be in the same physical entity as the SGW 1004. A policy and charging rules function entity (PCRF) 1006 provides quality of service (QOS) policies and charging criteria. A general packet radio service support node (SGSN) 1008 is a network node device that provides routing for data transmission in a universal mobile telecommunications system (UMTS). A home subscriber server (HSS) 1009 is a home subsystem of the UE, and is responsible for protecting user information including a current location of the user equipment, an address of a serving node, user security information, and packet data context of the user equipment, etc.

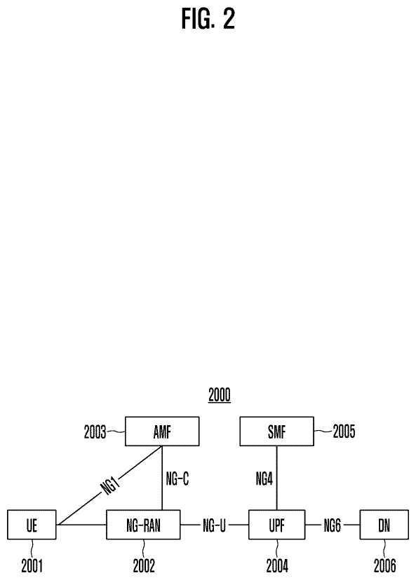

FIG. 2 illustrates an exemplary system architecture 2000 according to various embodiments of the present disclosure. Other embodiments of the system architecture 2000 can be used without departing from the scope of the present disclosure. A user equipment (UE) 2001 is a terminal device for receiving data. A next generation radio access network (NG-RAN) 2002 is a radio access network, which includes a base station (a gNB or an eNB connected to 5G core network 5GC, and the eNB connected to the 5GC is also called ng-gNB) that provides UE with interfaces to access the radio network. An access control and mobility management function entity (AMF) 2003 is responsible for managing mobility context and security information of the UE. A user plane function entity (UPF) 2004 mainly provides functions of user plane. A session management function entity SMF 2005 is responsible for session management. A data network (DN) 2006 includes, for example, services of operators, access of Internet and service of third parties.

For the convenience of description, the terms involved in the following description of the embodiments of the present disclosure and their explanations are as follows:
1. LTM (L1/L2 Triggered Mobility): Layer 1/Layer 2 triggered mobility;
2. CFRA: Contention Free Random Access;
3. CSI: Channel State Information;
4. CGI: Cell Global ID;
5. RLF: Radio Link Failure;
6. AMF: an access and mobility management function, which is a network element in the core of 5G network and is responsible for the access and mobility management of a 5G base station, wherein the 5G base station and the AMF are connected through an NG-C interface;
7. NG-RAN node: a new generation radio access network node, for example, a 5G base station, including a gNB or an ng-eNB;
8. gNB (next Generation Node B): a next generation base station node, for example, a 5G new radio (NR) base station;
9. gNB-DU: a gNB distributed unit, which has functions such as a radio link control (RLC) protocol, a medium access control (MAC) protocol and a physical layer (PHY) protocol; and
10. gNB-CU: a gNB central unit, which has functions such as a radio resource control (RRC) protocol, a service data adaptation protocol (SDAP) and a packet data convergence protocol (PDCP).

It should be understood that the names of the messages in the present disclosure are examples only and other names may be adopted. A new message may be defined for transmitting the information required to be transmitted between interfaces. It is also possible to add a new information element (IE) into an existing message in an existing interface specification to transmit the required information.

Exemplary embodiments of the present disclosure are further described below with reference to the accompanying drawings.

The text and drawings are provided as examples only to help understand the present disclosure. They should not be interpreted as limiting the scope of the present disclosure in any way. Although certain embodiments and examples have been provided, based on the disclosure herein, it will be apparent to those skilled in the art that changes may be made to the illustrated embodiments and examples without departing from the scope of the present disclosure.

For an LTM procedure, the UE accesses from a source cell to a target cell by means of LTM. In technical implementation, it cannot ensure that the access is successful every time. For example, due to various abnormal conditions, an LTM cell handover failure, a connection failure, or a radio link failure after the access to the target cell may occur. In these situations, the UE needs to select a cell. If the selected cell is an LTM candidate cell, the UE performs a random access channel (rach)-based LTM cell switch on the selected cell to achieve a fast recovery. However, if the cell selected by the UE is not an LTM candidate cell, the UE transmits an RRC re-establishment request to the selected cell. If a failure occurs frequently during the execution of the LTM, it cannot ensure the normal service of the UE, but may increase the interrupt latency of the service.

Therefore, it is required to be considered how to perform an optimization for the LTM mobility related procedure after a failure occurs so as to avoid similar failures in the subsequent LTM procedure to achieve a higher LTM switch success rate.

To this end, the present disclosure provides a scheme for analyzing an abnormal scenario where an LTM failure occurs and optimizing the abnormal scenario.

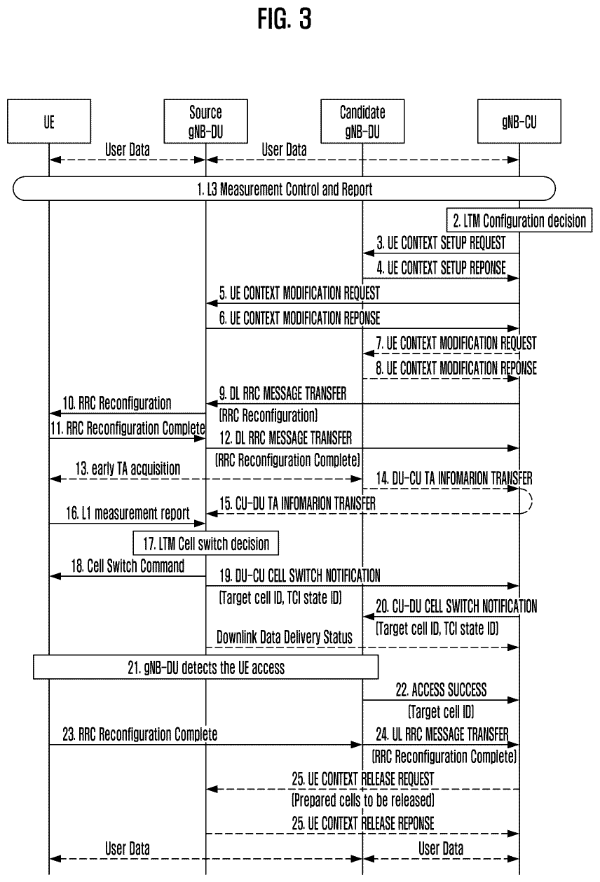

FIG. 3 illustrates a flowchart of an exemplary LTM procedure according to exemplary embodiments of the present disclosure. To illustrate the failure scenario that may occur during execution of the LTM, a normal LTM procedure is first introduced. The procedure shown in FIG. 3 is a scenario where a UE moves from a gNB-DU to another gNB-DU under the same gNB-CU during NR LTM. The procedure is described as follows.

### 1. L3 Measurement Control and Report

In an embodiment, the UE transmits a Measurement Report message (in which an L3 measurement result is reported) to a source gNB-DU, the message containing the measurement value of a neighboring cell. The source gNB-DU transmits a UL RRC MESSAGE TRANSFER message and transfers the received Measurement Report message to the gNB-CU.

2. The gNB-CU Decides to Initiate an LTM Configuration.

3. The gNB-CU transmits a UE CONTEXT SETUP REQUEST message to the candidate gNB-DU, the message containing a candidate cell ID, an LTM configuration ID of a candidate cell, an LTM configuration ID mapping list and a CSI resource configuration. The gNB-CU indicates the source gNB-DU ID and requests a physical random access channel (PRACH) resource from the candidate gNB-DU. The gNB-CU may request the candidate gNB-DU to provide a low layer configuration to generate a reference configuration.

4. If the candidate gNB-DU accepts the LTM configuration request, the candidate gNB-DU may transmit a UE CONTEXT SETUP RESPONSE message as a response, the message containing a low layer RRC configuration (e.g., a transmission channel indication (TCI) state configuration and a random access channel (RACH) configuration) and a CSI report configuration generated for the accepted target candidate cell.

5. The gNB-CU transmits a UE CONTEXT MODIFICATION REQUEST message to the source gNB-DU, the message containing the collected CSI report configuration, TCI stateconfiguration and RACH configuration of the accepted target candidate cells in other gNB-DUs.

6. The source gNB-DU transmits a UE CONTEXT MODIFICATION RESPONSE message as a response. The message may include a CSI report configuration generated for prepared candidate cells.

7. The gNB-CU transmits a UE CONTEXT MODIFICATION REQUEST message to the candidate gNB-DU, the message containing the CSI report configuration, the TCI state configuration, the RACH configuration and the LTM configuration ID of candidate cells in other candidate gNB-DUs. The gNB-CU may further provide a reference configuration of a low layer portion to the candidate gNB-DU. The gNB-CU may further provide an updated CSI resource configuration to the candidate gNB-DU. As a possibility, the candidate cell and the source cell may be the same cell.

8. The candidate gNB-DU transmits a UE CONTEXT MODIFICATION RESPONSE message as a response, the message including an updated low layer configuration. The response transmitted by the candidate gNB-DU may further contain an updated CSI report configuration.

9. The gNB-CU transmits a DL RRC MESSAGE TRANSFER message to the source gNB-DU, the message containing the generated RRCReconfiguration message having the LTM configuration.

10. The source gNB-DU forwards the received RRCReconfiguration message to the UE.

11. The UE transmits an RRCReconfigurationComplete message to the source gNB-DU.

12. The source gNB-DU forwards the RRCReconfigurationComplete message to the gNB-CU through an UL RRC MESSAGE TRANSFER message.

13. Early synchronization is performed to obtain an early timing advance (TA) value.

14 and 15. The candidate gNB-DU transmits the TA value information and the associated CFRA resource information, candidate cell ID and source gNB-DU ID to the source gNB-DU through a DU-CU TA INFORMATION TRANSFER message and a CU-DU TA INFORMATION TRANSFER message. Here, the source gNB-DU ID is omitted in the CU-DU TA INFORMATION TRANSFER message.

16. The UE transmits a layer 1 measurement report to the source gNB-DU.

17. The source gNB-DU decides to perform an LTM cell switch on a candidate target cell.

18. The source gNB-DU transmits a Cell Switch Command to the UE.

19. The source gNB-DU transmits a DU-CU CELL SWITCH NOTIFICATION message to the gNB-CU, indicating that a Cell Switch command is initiated to the UE. A DU-CU CELL SWITCH NOTIFICATION includes a target cell ID and a TCI state ID.

20. The gNB-CU transmits the target cell ID and the TCI state ID to the target gNB-DU through the CU-DU CELL SWITCH NOTIFICATION.

21. The target gNB-DU detects a successful access (a rach-less based or rach-based access procedures) of the UE.

22. The target gNB-DU transmits an ACCESS SUCCESS message to the gNB-CU and the target cell ID is carried.

23. The UE transmits an RRCReconfigurationComplete message to the target gNB-DU.

24. The target gNB-DU forwards the RRCReconfigurationComplete message to the gNB-CU through an UL RRC MESSAGE TRANSFER message.

25. The gNB-CU may transmit a UE CONTEXT RELEASE COMMAND message to the source gNB-DU to release the resource and configuration of the prepared cells (including the source cell).

26. The source gNB-DU transmits a UE CONTEXT RELEASE COMPLETE message to the gNB-CU as a response.

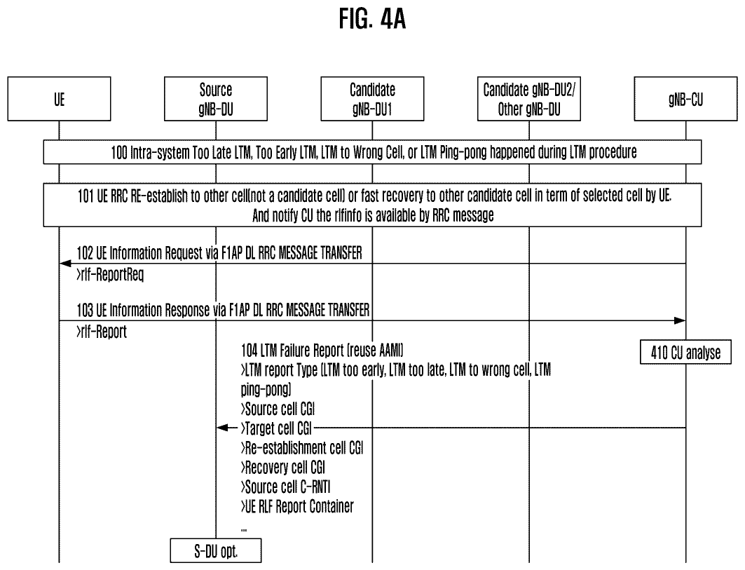

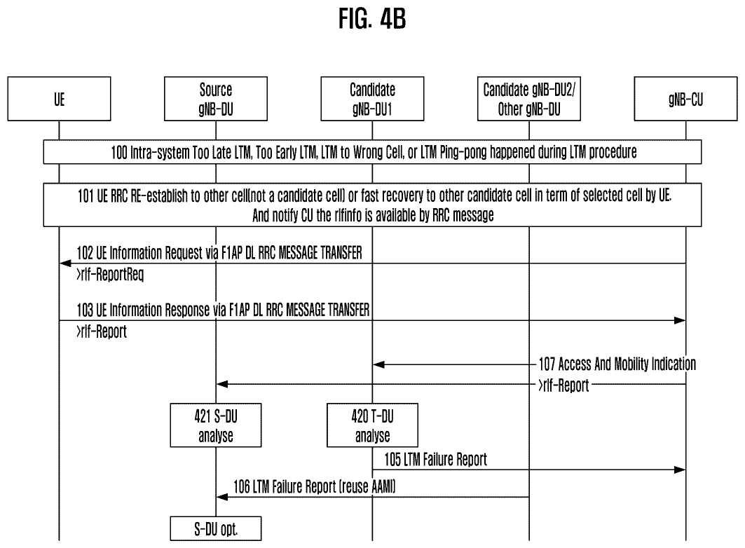

FIGS. 4A and 4B illustrate flowcharts of an LTM failure analysis and report in an LTM procedure according to an exemplary embodiment of the present disclosure. In this embodiment, the following failures may occur. For example, an LTM connection failure may occur before the execution of an intra-gNB-CU inter-gNB-DU LTM. Or a failure may occur during the execution of LTM (that is, the UE does not successfully complete an RA (random access) procedure, i.e., a rach-based procedure or a rach-less procedure, but accesses to a target cell). Or a radio link failure may occur immediately after a successful access to the target cell. Referring to FIGS. 4A and 4B, at step 100, an intra-system LTM failure in an LTM procedure occurs.

Here, the types of handover failures are as follows. In a corresponding handover failure scenario, there may be a corresponding LTM failure type during the LTM execution.

1. Too late handover, including too late LTM execution: an RLF occurs after the UE has stayed for a long period of time in the cell; the UE attempts to re-establish the radio link connection in a different cell.

2. Too early handover, including too early LTM execution: an RLF occurs shortly after a successful handover from a source cell to a target cell or a handover failure occurs during the handover procedure; the UE attempts to re-establish the radio link connection in the source cell.

3. Handover to wrong cell, including LTM execution to wrong cell: an RLF occurs shortly after a successful handover from a source cell to a target cell or a handover failure occurs during the handover procedure; the UE attempts to re-establish the radio link connection in a cell other than the source cell and the target cell.

4. Handover ping-pong, including LTM execution ping-pong: a UE is handed over from a source cell to a target cell, then within a predefined limited time the UE is handed over back to a source cell, while the coverage of the source cell was sufficient for the service used by the UE. The event may occur more than once.

In case of LTM, too late handover, too early handover and handover to wrong cell means too late LTM execution (or LTM too late), too early LTM execution (or LTM too early), and LTM execution to wrong cell (or LTM to wrong cell).

For the first three LTM failure scenarios as mentioned above (i.e., too late LTM execution, too early LTM execution, and LTM execution to wrong cell), when the above scenario occurs, the UE selects a cell. If the cell selected by the UE is an LTM candidate cell, the UE performs a rach-based LTM cell handover to achieve a fast recovery for a radio link. If the cell selected by the UE is not an LTM candidate cell, the UE initiates an RRC re-establishment request to the cell, attempting to re-establish the radio link connection.

For the first three LTM failure scenarios as mentioned above, in regardless of which one of the failure scenarios occurs, the UE informs at step 101, through an RRC message carrying an indication IE, the gNB-CU that there is available radio link failure (rlf) or handover failure (hof) information at the UE side. The used RRC message is, for example, an RRCReestablishmentComplete message, an RRCReconfigurationComplete message or an RRCSetupComplete message. The carried indication IE may be, for example, an rlf information available IE (rlf-InfoAvailable) contained in a UE-MeasurementsAvailable message. Then, at step 102, the gNB-CU requests the UE to report its radio link failure or handover failure information through a UE InformationRequest message, the message carrying an rlf report request information element (rlf-ReportReq IE). At step 103, the UE reports the radio link failure or handover failure information to the gNB-CU through a UE information response (UEInformationResponse) message, the UE information response message carrying an rlf report information element (rlf-Report IE). The RRC messages of the UE and the gNB-CU are forwarded by a currently serving gNB-DU (i.e., the gNB-DU to which a cell selected by the UE when performing a cell selection to recover the radio link connection after an LTM failure belongs) through an F1 application protocol (F1AP) DL RRC MESSAGE TRANSFER and an F1AP UL RRC MESSAGE TRANSFER. The DL RRC MESSAGE TRANSFER and the UL RRC MESSAGE TRANSFER respectively contain an RRC container carrying a UE information request and a UE information response.

According to an exemplary embodiment of the present disclosure, after the gNB-CU receives the rlf report related information reported by the UE, an analysis for the cause of an LTM failure may be performed by the gNB-CU or the gNB-DU. Depending on which node analyzes the cause of the LTM failure, there may be two alternative schemes shown in FIGS. 4A and 4B.

In the exemplary embodiment shown in FIG. 4A, the analysis for the cause of the LTM failure is performed by the gNB-CU.

At step 104, the gNB-CU transmits LTM failure report information to a source gNB-DU.

Optionally, the LTM failure report information is transmitted to the source gNB-DU by means of a new LTM failure report message or by reusing an F1AP access and mobility indication (AAMI) message with the LTM failure report information carried. Optionally, the gNB-CU may notify the source gNB-DU of the LTM failure report information by other means. Then, the source gNB-DU performs an optimization on an LTM configuration (e.g., a mobility parameter) or an LTM triggering strategy. The optimization for the LTM configuration or the LTM triggering strategy may be, for example, updating the LTM configuration or the LTM triggering strategy.

Optionally, the analysis of the gNB-CU (e.g., step 410) may be included prior to step 104.

Optionally, at step 410, through the LTM failure related information contained in the rlf report reported by the UE, the gNB-CU may perform the analysis on the cause of the LTM failure at step 410. The LTM failure report information may be generated after the analysis is completed. In the exemplary embodiment shown in FIG. 4B, the analysis for the cause of the LTM failure is performed by a gNB-DU (a source gNB-DU or a target gNB-DU). Steps 100-103 in FIG. 4B are the same as steps 100-103 in FIG. 4A, and thus will not be repeatedly described here.

Optionally, the analysis of a target DU (e.g., step 420) may be included prior to step 105.

Optionally, after collecting the LTM failure related information contained in the rlf report reported by the UE, the gNB-CU transmits, at step 107, the information to the gNB-DU for analysis to generate the LTM failure report information. According to the LTM failure scenario, the gNB-CU transmits the collected rlf report information to the source gNB-DU or a candidate (target) gNB-DU for analysis. For example, for too late LTM execution, the gNB-CU transmits the rlf report information to the source gNB-DU, and the source gNB-DU performs the analysis and performs the optimization on the LTM configuration and/or the LTM triggering strategy at step 421. For the handover failure of the UE in the situation of too early LTM execution or LTM execution to wrong cell, the gNB-CU may transmit the rlf report information to the source gNB-DU, and the source gNB-DU performs the analysis and performs the optimization on the LTM configuration and/or the LTM triggering strategy at step 421. Optionally, the gNB-CU may transmit the rlf report information to the gNB-DU through the F1AP AAMI message carrying the rlf report information.

Moreover, for the rlf occurring after the successful access of the UE to the target cell in the situation of too early LTM execution or LTM execution to wrong cell, the gNB-CU may transmit the rlf report information to the candidate gNB-DU for analysis. The candidate gNB-DU is the gNB-DU where the target cell is, and the radio link failure occurs immediately after the UE successfully accesses the target cell. Optionally, in the embodiment of FIG. 4B, at step 107, the gNB-CU may transmit the rlf report information to the candidate gNB-DU through the AAMI message carrying the rlf report information. Optionally, the candidate gNB-DU performs the analysis on the cause of the LTM failure at step 420 and generates the LTM failure report information after completing the analysis. The candidate gNB-DU transmits the LTM failure report information to the gNB-CU at step 105, and then the gNB-CU transmits the LTM failure report information to the source gNB-DU at step 104. Thereafter, the source gNB-DU performs the optimization on the LTM configuration and/or the LTM triggering strategy.

In the embodiment of FIG. 4A, the gNB-CU transmits the LTM failure report information generated by performing the analysis on the LTM failure to the source gNB-DU. Optionally, the gNB-CU may transmit the LTM failure report information to the source gNB-DU by means of a new LTM failure report message or by reusing an FIAP AAMI message carrying the LTM failure report information, or the gNB-CU may notify the source gNB-DU of the LTM failure report information by other means. Then, the source gNB-DU performs the optimization on the LTM configuration and/or the LTM triggering strategy.

In the embodiment of FIG. 4B, the gNB-DU transmits the LTM failure report information generated by performing the analysis on the LTM failure to the source gNB-DU. Optionally, the gNB-DU may transmit the LTM failure report information to the gNB-CU by means of a new LTM failure report message or by other means, and then the gNB-CU transmits the LTM failure report information to the source gNB-DU by means of a new LTM failure report message or by reusing an F1AP AAMI message carrying the LTM failure report information, or the gNB-CU notifies the source gNB-DU of the LTM failure report information by other means. Then, the source gNB-DU performs the optimization on the LTM configuration and/or the LTM triggering strategy.

Regardless of that the analysis on the LTM failure is performed by the gNB-CU or by the gNB-DU, the LTM failure report information generated after the analysis is completed may be transmitted to the source gNB-DU. Then the source gNB-DU performs the optimization on the LTM configuration and/or the LTM triggering strategy. This is because, during the preparation of the LTM, the source gNB-DU generates a CSI report configuration (which may be contained in LTM-CSI-ReportConfig or LTM-CSI-ReportConfigToAddModList) for prepared candidate cells. A principle is that the node who generates the configuration is responsible for optimizing the configuration. Since the CSI report configuration for the candidate cell is generated by the source gNB-DU, the optimization for the corresponding configuration may also be performed by the source gNB-DU. Accordingly, the LTM failure report information may be transmitted to the source gNB-DU. Then, the source gNB-DU performs an optimization on an LTM CSI report configuration (LTM-CSI-ReportConfig) parameter.

Moreover, regarding the triggering of the LTM, the source gNB-DU decides to select a target cell according to the L1 measurement report reported by the UE, and then transmits a cell switch command carrying a target cell ID to instruct the UE to perform a handover. Since both the generation of the configuration of the measurement report of the candidate cell and the triggering of the LTM cell switch command are determined by the source gNB-DU, it is reasonable that the source gNB-DU performs the optimization on the LTM configuration, the mobility parameter and/or the adjustment on the LTM triggering strategy. Therefore, the LTM failure report generated after the gNB-CU or the gNB-DU performs the analysis may be finally transmitted to the source gNB-DU.

In the above procedure, the LTM failure report message or information generated by the gNB-CU, the LTM failure report message or information generated by performing the analysis by the candidate gNB-DU, or the LTM failure report message or information transmitted to the gNB-CU and then forwarded to the source gNB-DU by the gNB-CU may contain one or more of the following information.
LTM Report Type: indicating that the failure type is too early LTM execution, too late LTM execution, LTM execution to wrong cell or LTM execution ping-pong. Here, the LTM execution ping-pong type may be determined by the gNB-CU according to a visited cell information list (VisitedCellInfoList) in a mobility history report (MobilityHistoryReport) IE reported by the UE, or according to the source cell and the target cell in which the UE resides through the LTM and the residence time which are known by the gNB-CU.
CGI of source cell: the CGI of the source cell for the LTM procedure in the source gNB-DU.
CGI of target cell: the CGI of the target cell for the LTM procedure in the candidate gNB-DU.
CGI of re-establishment cell: the CGI of a non-candidate cell a connection to which the UE attempts to re-establish after the failure or the CGI of a candidate cell to which the UE successfully connects after the failure. This information is contained when the LTM report type is the LTM execution to wrong cell.
CGI of recovery cell: the CGI of a candidate cell to which the UE has ever successfully re-connected, and which is selected by the UE after the LTM failure, when the LTM report type is the LTM execution to wrong cell.
C-RNTI in source cell: a cell radio network temporary identifier allocated at the source gNB-DU, which is used in the source cell after a handover failure or a radio link failure, the C-RNTI being used by the source gNB-DU to obtain the saved UE context to match the corresponding LTM failure report.
C-RNTI in target cell: the cell radio network temporary identifier allocated at the target gNB-DU, which is used in the target cell after a radio link failure or a handover failure is detected. Through this information, the gNB-DU receiving an rlf report can determine whether the radio link failure involved in the rlf report occurs on the gNB-DU without decoding the content of the rlf report.
C-RNTI in last serving cell: the cell radio network temporary identifier allocated at the last serving cell, which is used in the last serving cell after a radio link failure or a handover failure is detected. Through this information, the gNB-DU receiving an rlf report can determine whether the radio link failure involved in the rlf report occurs on the gNB-DU without decoding the content of the rlf report.
UE RLF report container: a UE radio link failure report container, including a new radio rlf report IE (nr-RLF-Report-r16 IE) in a UE INFORMATION RESPONSE message defined in 3GPP standard specification TS 38.331.
TA invalidation indication: indicating that the occurrence of a rach-less access failure is due to an invalid TA. Optionally, a TA invalidation conclusion may be obtained by comparing a TA value received from the source gNB-DU (carried in the cell switch command) and an actual TA value (for performing the rach-based access after the rach-less failure).

The source gNB-DU performs the optimization on the LTM configuration and/or the LTM triggering strategy based on the received information.

The above features for the LTM failure in the intra-gNB-CU inter-gNB-DU LTM procedure are also applicable to the scenario where an LTM failure occurs in an intra-gNB-CU intra-gNB-DU LTM procedure. After the gNB-CU receives the rlf report related information reported by the UE, it is possible to select the gNB-CU or the gNB-DU to perform the analysis on the cause of the LTM failure according to the embodiments shown in FIGS. 4A and 4B.

In addition, for the rlf occurring after the successful access of the UE to the target cell in the situation of LTM execution to wrong cell, the following situations may be further considered on the basis of the above embodiments:
If a re-establishment cell (or referred to as a suitable cell) selected by the UE after the rlf occurs is one of the candidate cells provided by the node (gNB-CU) initiating the LTM, but not one of the candidate cells selected by the (candidate) target gNB-DU, this is a wrong target cell selection at the (candidate) target gNB-DU. In this situation, the gNB-CU may notify the (candidate) target gNB-DU of the analysis report to perform the optimization on the LTM configuration and/or the LTM triggering strategy. For example, this cell (suitable cell) may be added to the LTM candidate cell list to configure the cell to the UE.
Otherwise, this is a wrong candidate cell list selection at the node (gNB-CU) initiating the LTM. Thus, it is required to perform the optimization on the LTM configuration and/or the LTM triggering strategy at the side of the gNB-CU, or to perform the optimization on the LTM configuration and/or the LTM triggering strategy at the side of the source gNB-DU.

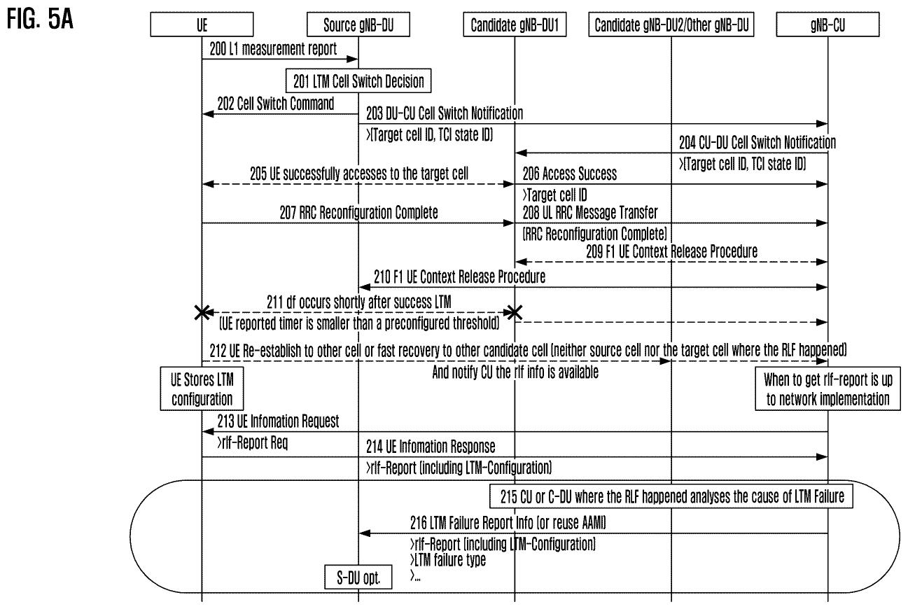

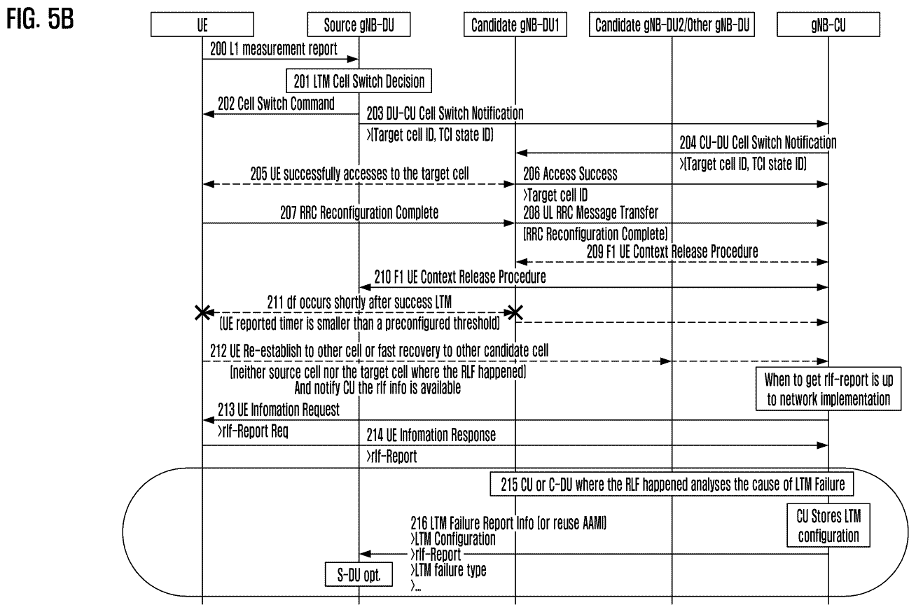

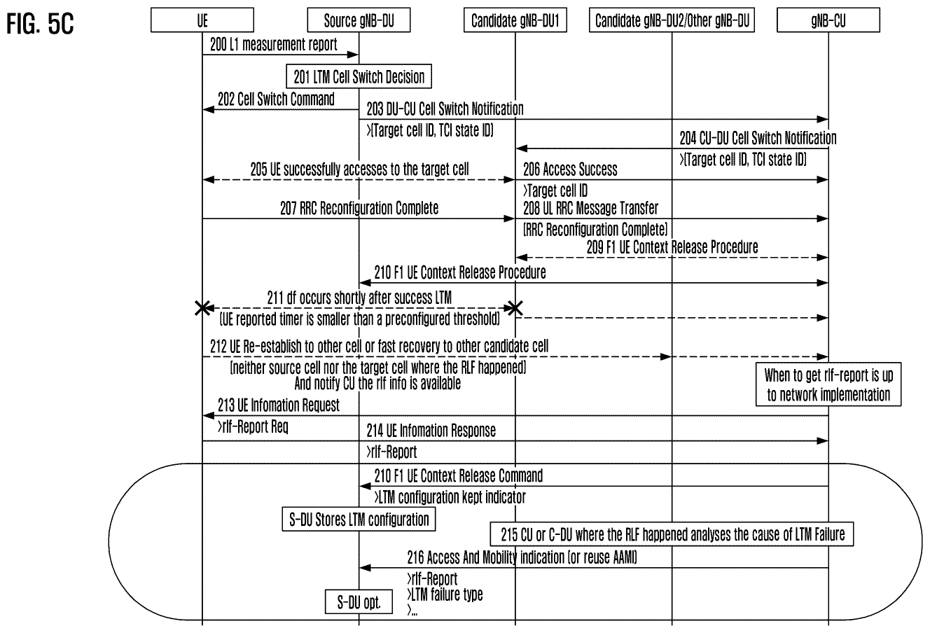

FIGS. 5A, 5B and 5C are flowcharts of an LTM configuration information storage and transmission in an LTM procedure according to an exemplary embodiment of the present disclosure. As described above, for example, after receiving the LTM failure report message or related information according to the embodiments shown in FIGS. 4A and 4B, the source gNB-DU performs the optimization on the LTM configuration and/or the LTM triggering strategy. However, in some scenarios of the LTM failure, the parameters related to LTM mobility may have been released at the side of the source gNB-DU along with a UE context, which makes the optimization on the LTM configuration and/or the LTM triggering strategy unable to be properly performed. FIGS. 5A, 5B and 5C provide exemplary embodiments for this issue.

The normal LTM procedure is already described above with reference to FIG. 3. Similarly, in the embodiments of FIGS. 5A, 5B and 5C, after the preparation for an LTM resource is completed, a UE reports a low layer measurement report (e.g., a Layer 1 (L1) measurement report) at step 200. A source gNB-DU makes an LTM cell switch decision according to the measurement report of the UE at step 201 and transmits a cell switch command carrying a target cell ID to the UE at step 202. The source gNB-DU transmits a DU-CU CELL SWITCH NOTIFICATION to the gNB-CU at step 203, and the gNB-CU forwards a CU-DU CELL SWITCH NOTIFICATION to a candidate gNB-DU at step 204. The DU-CU/CU-DU CELL SWITCH NOTIFICATION carries the target cell ID. Optionally, after the UE successfully accesses a target cell at step 205, the corresponding candidate gNB-DU transmits an ACCESS SUCCESS message carrying the target cell ID to the gNB-CU at step 206. The UE transmits an RRCReconfigurationComplete message to the candidate gNB-DU at step 207, and the candidate gNB-DU transmits a UL RRC MESSAGE TRANSFER message carrying the RRCReconfigurationComplete to the gNB-CU at step 208. At step 210, the gNB-CU triggers an F1 UE context release procedure to the source gNB-DU. Optionally, at step 209, the gNB-CU triggers the F1 UE context release procedure to the candidate gNB-DU.

For the scenario of LTM execution to wrong cell, in the situation where an rlf failure occurs (the timer value reported by the UE is less than a pre-configured threshold value) at step 211 shortly after the UE successfully accesses the target cell, the UE performs a cell selection to reconnect to an other cell, or quickly recovers a connection to an other candidate cell, and notifies the gNB-CU that there is available rlf or hof information at the side of the UE. The other cell and the other candidate cell here are neither a source cell nor the target cell where the rlf occurs. What time the gNB-CU obtains the rlf report from the UE depends on a network implementation.

For the scenario of LTM execution to wrong cell, in the situation where the rlf occurs immediately after the UE successfully accesses the target cell, after receiving the ACCESS SUCCESS message of the candidate gNB-DU, the gNB-CU may trigger a UE CONTEXT RELEASE COMMAND or a UE CONTEXT MODIFICATION REQUEST procedure to the source gNB-DU to release the LTM configuration of the UE with respect to the source cell. For example, in a non-subsequent LTM configuration, after the UE accesses the target cell and executes LTM once, resources of other candidate cells need to be released. Optionally, in a subsequent LTM configuration, if the source cell is not used as a candidate cell, the resource of the source cell needs to be released. After the rlf occurs, the UE performs a cell selection to re-establish a radio link connection, as shown in step 212. Another cell selected by the UE may be a candidate cell in the candidate gNB-DU or a non-candidate cell in another gNB-DU.

After completing the re-establishment, the UE may inform the gNB-CU through an RRC message that there is available radio link failure or handover failure information at the side of the UE. Then, the gNB-CU requests the UE to report the information through a UE information request message (carrying an rlf report request IE) at step 213. Next, the UE reports the information to the gNB-CU through a UE information response message (carrying an rlf report IE) at step 214. At step 215, the gNB-CU or the gNB-DU analyzes the cause of the LTM failure. The RRC messages of the UE and the gNB-CU are forwarded by a gNB-DU currently serving the UE through an RRC container (carrying a UE information request or a UE information response) contained in the F1AP message DL RRC MESSAGE TRANSFER and the UL RRC MESSAGE TRANSFER. After the LTM failure occurs, the UE performs a cell selection to recover a radio link connection, and the gNB-DU to which the selected cell belongs is the gNB-DU currently serving the UE.

An exemplary embodiment of the LTM configuration in the LTM procedure is described below with reference to FIGS. 5A, 5B and 5C.

FIG. 5A illustrates an embodiment in which the LTM configuration is stored by the UE. With respect to the LTM configuration, since the UE is already configured by the gNB-CU through the RRCReconfiguration message at an LTM resource configuration preparation stage, there is the configuration information at the side of the UE. Since the UE knows that the radio link failure occurs, the UE may have the following actions. The UE may include the LTM configuration information in the rlf report IE when the rlf report is generated in the situation of the radio link failure. After the gNB-CU obtains the rlf report, the gNB-CU or the gNB-DU may perform the analysis on the cause of the LTM failure at step 215, the specific process of which may be, for example, according to the embodiments of FIGS. 4A and 4B.

When generating the LTM failure report message or information, or receiving the LTM failure report message or information generated by performing the analysis by the candidate gNB-DU, the gNB-CU needs to transmit the LTM failure report message or information to the source gNB-DU. At this time, at step 216, the rlf report IE information may be carried by means of a new LTM failure report message or by reusing an FAP AAMI message and transmitted to the source gNB-DU along with the LTM failure report message or information. In this way, although the source gNB-DU have released the UE context, the source gNB-DU obtains the LTM configuration when receiving the LTM failure report and the rlf report IE information. Then, the source gNB-DU performs the optimization on the LTM configuration and/or the LTM triggering strategy.

FIG. 5B illustrates an embodiment in which the LTM configuration is stored by the gNB-CU. When receiving the ACCESS SUCCESS message of the candidate gNB-DU at step 206, the gNB-CU may trigger the UE CONTEXT RELEASE COMMAND or the UE CONTEXT MODIFICATION REQUEST procedure to the source gNB-DU at step 210, to release the LTM configuration of the UE with respect to the source cell. For example, in the non-subsequent LTM configuration, after the UE accesses the target cell and executes the LTM once, other candidate resources need to be released. Optionally, in the subsequent LTM configuration, if the source cell is not used as a candidate cell, the resource of the source cell needs to be released. To prevent the situation that the rlf occurs immediately after the successful access of the UE, and the gNB-CU has triggered the context release of the source cell, it is possible to define the action of the gNB-CU as follows: after receiving the ACCESS SUCCESS message, the gNB-CU may store the mobility-related LTM configuration of the source cell, release the mobility-unrelated LTM configuration, and normally trigger the context release procedure of the source cell to the source gNB-DU. After the gNB-CU receives the rlf report, the gNB-CU or the gNB-DU may perform the analysis on the cause of the failure at step 215, the specific process of which may be, for example, according to the embodiments of FIGS. 4A and 4B.

When generating the LTM failure report message or information, or receiving the LTM failure report message or information generated by performing the analysis by the candidate gNB-DU, the gNB-CU may transmit the LTM failure report message or information to the source gNB-DU. At this time, at step 216, the stored LTM configuration and the rlf report IE information may be carried by means of a new LTM failure report message or by reusing an F1AP AAMI message, and transmitted to the source gNB-DU. Then, the gNB-CU may delete the stored LTM configuration. In this way, although the source gNB-DU has released the UE context, the source gNB-DU may obtain the LTM configuration when receiving the LTM failure report and the rlf report IE information. Then, the source gNB-DU performs the optimization on the LTM configuration and/or the LTM triggering strategy.

If the UE successfully accesses the target cell and no rlf occurs, there is no need for the gNB-CU to keep the LTM configuration of the UE. In the scenario of intra-gNB-CU inter-gNB-DU LTM, since the UE is in the same gNB-CU, the gNB-CU knows whether an rlf occurs after the UE accesses the target cell. If the rlf occurs, the LTM configuration kept by the gNB-CU is useful. Then, the kept LTM failure report message may be carried when the LTM failure report message or information or the rlf report IE information is transmitted to the source gNB-DU, and then deleted by the gNB-CU itself. If the rlf does not occur, the kept LTM configuration may be deleted by the gNB-CU itself.

FIG. 5C illustrates an embodiment in which the LTM configuration is stored by the gNB-CU. When receiving the ACCESS SUCCESS message of the candidate gNB-DU at step 206, the gNB-CU may trigger the UE CONTEXT RELEASE COMMAND or the UE CONTEXT MODIFICATION REQUEST procedure to the source gNB-DU at step 210, to release the LTM configuration of the UE with respect to the source cell. For example, in the non-subsequent LTM configuration, after the UE accesses the target cell and executes the LTM once, other candidate resources need to be released. Optionally, in the subsequent LTM configuration, if the source cell is not used as a candidate cell, the resource of the source cell needs to be released. To prevent the situation that the rlf occurs immediately after the successful access of the UE, and the gNB-CU has triggered the context release of the source cell, an indication IE may be carried in the message of the UE CONTEXT RELEASE COMMAND or the UE CONTEXT MODIFICATION REQUEST transmitted at step 210.

For example, an LTM configuration kept indicator may be carried. Optionally, a cell ID (e.g., the CGI of a source cell) may be carried. Through the carried indication IE, the gNB-DU is notified to store the LTM configuration related to the mobility of the source cell in the UE context and release the mobility-unrelated LTM configuration. After the gNB-CU obtains the rlf report, the gNB-CU or the gNB-DU may perform the analysis on the cause of the failure at step 215, the specific process of which may be, for example, according to the embodiments of FIGS. 4A and 4B. When generating the LTM failure report message or information, or receiving the LTM failure report message or information generated by performing the analysis by the candidate gNB-DU, the gNB-CU needs to transmit the LTM failure report message or information to the source gNB-DU. At this time, at step 216, the LTM failure report information and the rlf report IE information may be carried by means of a new LTM failure report message or by reusing an F1AP AAMI message, and transmitted to the source gNB-DU. The source gNB-DU associates the LTM failure report information with the stored LTM configuration when receiving the LTM failure report. Then, the source gNB-DU performs the optimization on the LTM configuration and/or the LTM triggering strategy.

If the UE successfully accesses the target cell and no rlf occurs, the gNB-CU informs gNB-DU that there is no need for the gNB-DU to keep the LTM configuration of the UE. In the scenario of intra-gNB-CU inter-gNB-DU LTM, since the UE is in the same gNB-CU, the gNB-CU knows whether an rlf occurs after the UE accesses the target cell. If the rlf occurs, the LTM configuration kept by the gNB-DU may be useful. When receiving the LTM failure report, the gNB-DU associates the kept LTM configuration with the received LTM failure report, and then deletes the kept LTM configuration by itself. If the rlf does not occur, the kept LTM configuration can be deleted. For example, the source gNB-DU may delete the kept LTM configuration in the following way.

Optionally, the gNB-CU may notify the source gNB-DU to perform the releasing.
If the gNB-CU previously triggers a UE CONTEXT RELEASE COMMAND to the source gNB-DU to release the UE context, then there is no UE context of F1. At this time, a UE non-associated signaling may be used to notify the source gNB-DU to release the kept LTM configuration.
If the gNB-CU previously triggers a UE CONTEXT MODIFICATION REQUEST to the source gNB-DU to release the UE context with respect to the source cell, then a UE associated command may be triggered again to delete the kept LTM configuration. For example, there may be another candidate cell on the source gNB-DU, but if the source cell does not act as a candidate cell, the resource of the source cell needs to be released. In this situation, the gNB-CU triggers the UE CONTEXT MODIFICATION REQUEST to the source gNB-DU to perform the UE context release with respect to the source cell. For example, the gNB-CU may use the UE CONTEXT RELEASE COMMAND or the UE CONTEXT MODIFICATION REQUEST to carry an indication IE, to instruct the source gNB-DU to delete the kept LTM configuration. The carried indication IE may be, for example, an LTM configuration released indicator. Optionally, a cell ID (e.g., the CGI of the source cell) may be carried.

Optionally, the maximum keeping time of the source gNB-DU for the LTM configuration may be within 2 hours, because the rlf report of the UE has a maximum validity time of 2 hours.

In the embodiment shown in FIG. 5A, the mobility-related LTM configuration information mentioned above may be contained in the rlf report IE by the UE. In the embodiment shown in FIG. 5B, the mobility-related LTM configuration information mentioned above may be stored by the gNB-CU and contained in the LTM failure report message or information transmitted to the source gNB-DU. In the embodiment shown in FIG. 5C, an indication may be carried when the gNB-CU notify the source gNB-DU to release the UE context of the source cell, for notifying the source gNB-DU to store the LTM configuration related to the mobility of the source cell in the UE context and release the mobility-unrelated LTM configuration. Then the source gNB-DU performs the corresponding action.

The mobility-related LTM configuration information mentioned in each of the above embodiments may contain one or more of the following information.
LTM candidate cell list: containing each candidate cell ID, the maximum number of candidate cells in the list being maxNrofCellsLTM-r18. Optionally, the LTM candidate cell list may be represented by an ltm-CandidateIdList or an LTM configuration ID mapping list.
LTM candidate cell ID: the LTM candidate cell ID may be represented by the CGI of an NR cell, containing ID information of each LTM candidate cell. Alternatively, a corresponding LTM candidate cell ID may be represented by an LTM candidate ID (LTM-CandidateId) or an LTM configuration ID, because there is a corresponding mapping relationship among the three.
LTM source cell ID: the LTM source cell ID may be represented by the CGI of an NR cell. Alternatively, a corresponding LTM source cell ID may be represented by an LTM candidate ID (LTM-CandidateId) or an LTM configuration ID, because there is a corresponding mapping relationship among the three if the source cell is also used as a candidate cell in the subsequent LTM configuration.
LTM CSI resource configuration (LTM-CSI-ResourceConfig): corresponding to configuration information of one or more CSI resources of one or more LTM candidate cells with respect to an LTM measurement and being contained in ltm-CSI-ResourceConfigToAddModList in LTM-Config IE defined in 3GPP standard specification TS 38.331. Optionally, the ltm-CSI-ResourceConfigToAddModList may configure a plurality of LTM CSI resource configurations, and all the LTM CSI resource configurations may be represented by the ltm-CSI-ResourceConfigToAddModList.
LTM CSI report configuration (LTM-CSI-ReportConfig): corresponding to configuration information for performing a corresponding measurement report on one or more CSI resources (i.e., corresponding to one LTM CSI resource configuration) of one or more LTM candidate cells with respect to an LTM measurement, and being contained in LTM-CSI-ReportConfigToAddModList in CSI-MeasConfig in ServingCellConfig in CellGroupConfig 1E defined in 3GPP standard specification TS 38.331. Optionally, the ltm-CSI-ReportConfigToAddModList may configure a plurality of LTM CSI report configurations, and all the LTM CSI report configurations may be represented by the Itm-CSI-ReportConfigToAddModList.

For another scenario of LTM execution to wrong cell, in the situation where the UE does not successfully access the target cell (i.e., a handover failure occurs), the above three alternative schemes are still applicable. In the situation where a failure occurs when the UE accesses the target cell, the UE performs the cell selection to re-establish the radio link connection at step 212. Another cell selected by the UE may be a candidate cell in the candidate gNB-DU or a non-candidate cell in another gNB-DU. After completing the re-establishment, the UE may inform the gNB-CU through the RRC message that there is available radio link failure or handover failure information at the side of the UE. Then, the gNB-CU requests the UE to report the information through the UE information request message (carrying the rlf report request IE) at step 213. Next, the UE reports the information to the gNB-CU through the UE information response message (carrying the rlf report IE) at step 214.

For this scenario, the embodiment shown in FIG. 5A is applicable, and the LTM configuration may be carried in the rlf report by the UE. The embodiment shown in FIG. 5B is also applicable. When not receiving the ACCESS SUCCESS message carrying the target cell ID, or when receiving, after the UE cell selects an other LTM candidate, an ACCESS SUCCESS message carrying a different candidate cell ID (compared with the target cell ID in the DU-CU cell switch notification) from an other candidate gNB-DU, or when the UE selects an other cell which is not an LTM candidate cell, the gNB-CU may determine that the UE does not successfully access the target cell, and then, the embodiment shown in FIG. 5C may be used. When the gNB-CU determines that the UE does not successfully access the target cell, the LTM configuration in the UE context may be stored before the UE context is released. When the gNB-CU generates the LTM failure report information or message and the LTM failure report information or message needs to be transmitted to the source gNB-DU, the stored LTM configuration and the rlf report IE information are carried to be transmitted to the source gNB-DU, and then the stored LTM configuration is released.

Optionally, the gNB-CU may reuse the F1AP AAMI message to carry the received rlf report information and the stored LTM configuration, and transmit the received rlf report information and the stored LTM configuration to the source gNB-DU to perform the analysis and perform the optimization on the LTM configuration and/or the LTM triggering strategy. The embodiment shown in FIG. 5C is also applicable. In the situation where the gNB-CU determines that the UE does not successfully access the target cell, when the UE context is released, an indication IE may be carried in the UE CONTEXT RELEASE COMMAND or the UE CONTEXT MODIFICATION REQUEST message to notify the source gNB-DU to store the LTM configuration related to the mobility of the source cell in the UE context and release the mobility-unrelated LTM configuration. The carried indication IE may include, for example, an LTM configuration kept indicator. Optionally, the cell ID of the source cell (e.g., the CGI of the source cell) may be carried. After the gNB-CU generates the LTM failure report information or message by performing the analysis, the LTM failure report information or message needs to be transmitted to the source gNB-DU. At this time, the rlf report IE information is carried to be transmitted to the source gNB-DU. The source gNB-DU associates the received LTM failure report information with the stored LTM configuration, and then performs the optimization on the LTM configuration and/or the LTM triggering strategy.

Optionally, the gNB-CU reuses the F1AP AAMI message to carry the received rlf report information, and transmit the received rlf report information to the source gNB-DU. Then, the source gNB-DU associates the rlf report information with the stored LTM configuration, to perform the analysis and perform the optimization on the LTM configuration and/or the LTM triggering strategy.

The situation of too early LTM execution includes a scenario where the rlf occurs immediately after the UE successfully accesses the target cell, and then the radio link is quickly recovered in the source cell, and a scenario where a handover failure occurs before the UE successfully accesses the target cell, and then the radio link is quickly recovered in the source cell. In the above situations of too early LTM execution, the embodiment shown in FIG. 5A is still applicable regardless of that the cause of the failure is analyzed by the gNB-CU, by the candidate gNB-DU (when the rlf occurs immediately after the UE successfully accesses the target cell), or by the source gNB-DU (when the handover failure occurs before the UE successfully access the target cell). In the embodiment shown in FIG. 5A, the UE may contain the LTM configuration in the rlf report. In the embodiment shown in FIG. 5B, the gNB-CU stores the LTM configuration in the UE context. When the gNB-CU generates the LTM failure report information or message required to be transmitted to the source gNB-DU, the stored LTM configuration and the rlf report IE information are carried to be transmitted to the source gNB-DU, and then the stored LTM configuration is released. The source gNB-DU performs the optimization on the LTM configuration and/or the LTM triggering strategy based on the received information.

Optionally, for the situation where the rlf occurs immediately after the UE successfully accesses the target cell, and then the radio link is quickly recovered in the source cell, the gNB-CU may transmit, after receiving the LTM failure report information or message generated by the candidate gNB-DU, the stored LTM configuration, the received LTM failure report information and the rlf report IE information to the source gNB-DU, and then release the stored LTM configuration. The source gNB-DU performs the optimization on the LTM configuration and/or the LTM triggering strategy based on the received information. Optionally, for the situation where the handover failure occurs before the UE successfully accesses the target cell, and then the radio link is quickly recovered in the source cell, the gNB-CU may reuse an F1AP AAMI message to carry the received rlf report information and the stored LTM configuration, and transmit the received rlf report information and the stored LTM configuration to the source gNB-DU for self-analysis and optimization.

For the situation of too late LTM execution, the embodiment shown in FIG. 5A is still applicable regardless of that the UE selects an LTM candidate cell or an other cell that is not an LTM candidate cell during the cell selection to recover the radio link connection. In the embodiment shown in FIG. 5A, the UE contains the LTM configuration in the rlf report. In the embodiment shown in FIG. 5B, the gNB-CU stores the LTM configuration in the UE context. When the gNB-CU generates the LTM failure report information or message required to be transmitted to the source gNB-DU, the stored LTM configuration and the rlf report IE information are carried to be transmitted to the source gNB-DU, and then the stored LTM configuration is released. The source gNB-DU performs the optimization on the LTM configuration and/or the LTM triggering strategy based on the received information.

Optionally, the gNB-CU may reuse the F1AP AAMI message to carry the received rlf report information and the stored LTM configuration and transmit the received rlf report information and the stored LTM configuration to the source gNB-DU for self-analysis and optimization. The embodiment shown in FIG. 5C is also applicable. When the gNB-CU triggers the release of the UE context, a cell-based indication IE may be carried in the UE CONTEXT RELEASE COMMAND or the UE CONTEXT MODIFICATION REQUEST message, to notify the source gNB-DU to store the LTM configuration related to the mobility of the source cell in the UE context and release the mobility-unrelated LTM configuration. The carried indication IE may be, for example, an LTM configuration kept indicator.

Optionally, a cell ID (e.g., the CGI of a source cell) may be carried. After the gNB-CU generates, through the analysis, the LTM failure report information or message required to be transmitted to the source gNB-DU, the rlf report IE information is carried to be transmitted to the source gNB-DU. The source gNB-DU associates the received LTM failure report information with the stored LTM configuration, and then performs the optimization on the LTM configuration and/or the LTM triggering strategy. Optionally, the gNB-CU may reuse the F1AP AAMI message to carry the received rlf report information, and transmit the received rlf report information to the source gNB-DU. Then, the source gNB-DU associates the rlf report information with the stored LTM configuration for self-analysis and optimization.

The mobility-related LTM configuration information mentioned in each of the above embodiments may contain one or more of the following information.
LTM candidate cell list: containing each candidate cell ID, the maximum number of candidate cells in the list being maxNrofCellsLTM-r18. Optionally, the LTM candidate cell list may be represented by an ltm-CandidateIdList or an LTM configuration ID mapping list.
LTM candidate cell ID: the LTM candidate cell ID may be represented by the CGI of an NR cell, containing ID information of each LTM candidate cell. Optionally, a corresponding LTM candidate cell ID may be represented by an LTM candidate ID (LTM-CandidateId) or an LTM configuration ID, because there is a corresponding mapping relationship among the three.
LTM source cell ID: the LTM source cell ID may be represented by the CGI of an NR cell. Optionally, a corresponding LTM source cell ID may be represented by an LTM candidate ID (LTM-CandidateId) or an LTM configuration ID, because there is a corresponding mapping relationship among the three if the source cell is also used as a candidate cell in the subsequent LTM configuration.
LTM CSI resource configuration (LTM-CSI-ResourceConfig): corresponding to configuration information of one or more CSI resources of one or more LTM candidate cells with respect to an LTM measurement and being contained in ltm-CSI-ResourceConfigToAddModList in LTM-Config IE defined in 3GPP standard specification TS 38.331. Optionally, the ltm-CSI-ResourceConfigToAddModList may configure a plurality of LTM CSI resource configurations, and all the LTM CSI resource configurations may be represented by the ltm-CSI-ResourceConfigToAddModList.
LTM CSI report configuration (LTM-CSI-ReportConfig): corresponding to configuration information for performing a corresponding measurement report on one or more CSI resources (i.e., corresponding to one LTM CSI resource configuration) of one or more LTM candidate cells with respect to an LTM measurement, and being contained in LTM-CSI-ReportConfigToAddModList in CSI-MeasConfig in ServingCellConfig in CellGroupConfig 1E defined in 3GPP standard specification TS 38.331. Optionally, the Itm-CSI-ReportConfigToAddModList may configure a plurality of LTM CSI report configurations, and all the LTM CSI report configurations may be represented by the ltm-CSI-ReportConfigToAddModList.

The embodiments described above for the intra-gNB-CU inter-gNB-DU LTM procedure are also applicable to the scenario where the LTM failure occurs during an intra-gNB-CU intra-gNB-DU LTM procedure. Specifically, the embodiments described above in combination with FIGS. 5A-5C are still applicable to the intra-gNB-CU intra-gNB-DU LTM procedure.

For the embodiment shown in FIG. 5A, the UE contains the LTM configuration in the rlf report. For the embodiment shown in FIG. 5B, the gNB-CU stores the LTM configuration in the UE context. When the gNB-CU generates the LTM failure report information or message required to be transmitted to the source gNB-DU, the stored LTM configuration and the rlf report IE information are carried to be transmitted to the source gNB-DU, and then the stored LTM configuration is released. The source gNB-DU performs the optimization on the LTM configuration and/or the LTM triggering strategy based on the received information. Optionally, the gNB-CU may reuse the F1AP AAMI message to carry the received rlf report information and the stored LTM configuration and transmit the received rlf report information and the stored LTM configuration to the source gNB-DU for self-analysis and optimization.

For the embodiment shown in FIG. 5C, when the gNB-CU triggers the release of the UE context, an indication IE may be carried in the UE CONTEXT MODIFICATION REQUEST message, to notify the source gNB-DU to store the LTM configuration related to the mobility of the source cell in the UE context and release the mobility-unrelated LTM configuration. The carried indication IE may include, for example, an LTM configuration kept indicator. Optionally, a source cell ID (e.g., the CGI of a source cell) may be carried. After the gNB-CU generates, through the analysis, the LTM failure report information or message required to be transmitted to the source gNB-DU, the rlf report IE information is carried to be transmitted to the source gNB-DU. The source gNB-DU associates the received LTM failure report information with the stored LTM configuration, and then performs the optimization on the LTM configuration and/or the LTM triggering strategy. Optionally, the gNB-CU may reuse the F1AP AAMI message to carry the received rlf report information, and transmit the received rlf report information to the source gNB-DU. Then, the source gNB-DU associates the rlf report information with the stored LTM configuration for self-analysis and optimization.

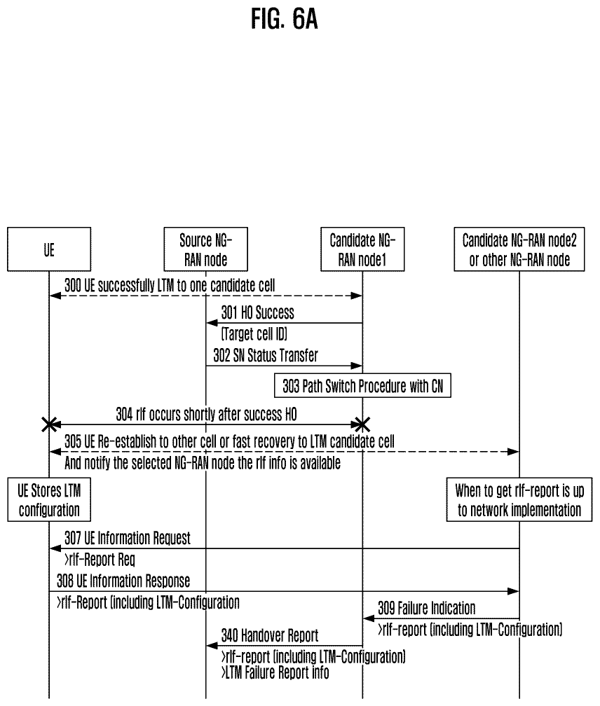

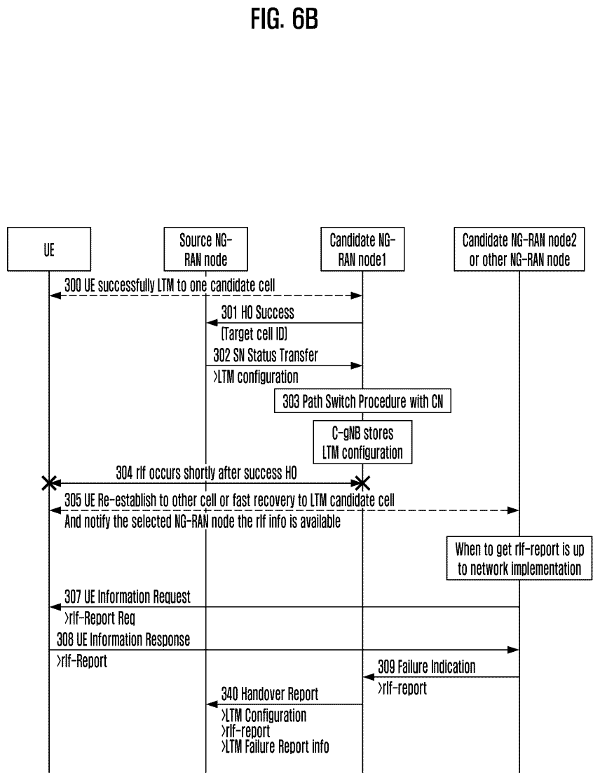

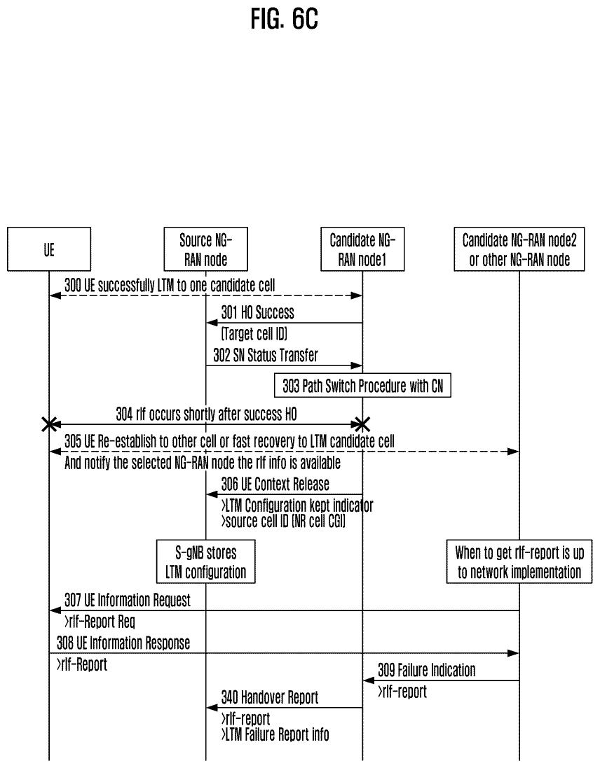

FIGS. 6A, 6B, and 6C illustrate flowcharts of a scheme of storing and transmitting an LTM configuration in an LTM procedure according to an exemplary embodiment of the present disclosure. This embodiment is for the scenario of inter NG-RAN node LTM. For the situation where an NG-RAN node is an architecture in which a gNB-CU and a gNB-DU are separate, an inter NG-RAN node is an inter-gNB-CU.

At step 300, a UE successfully accesses a target cell belonging to a candidate NG-RAN node 1. At step 301, the candidate NG-RAN node 1 transmits a HANDOVER SUCCESSmessage carrying a target cell ID to a source NG-RAN node. At step 302, the source NG-RAN node transmits a sequence number status transfer (SN Status Transfer) to the candidate NG-RAN node 1. At step 303, the candidate NG-RAN node 1 performs a path switch procedure with the CN.

For a scenario of LTM execution to wrong cell, a radio link failure occurs at step 304 shortly after the UE successfully accesses the candidate NG-RAN node 1. Then, the UE performs a cell selection at step 305 to access an other LTM candidate cell or an other cell, and informs, through an RRC message (e.g., an RRC re-establishment complete message, an RRCReconfigurationComplete message or an RRC setup complete message) carrying an indication IE, the currently selected NG-RAN node that there is an available radio link failure or handover failure message at the side of the UE. The carried indication IE may be, for example, an rlf information available IE (rlf-InfoAvailable) contained in a UE-measurements available (UE-MeasurementsAvailable) IE.

As described above, after the UE successfully accesses the target cell, the candidate NG-RAN node 1 transmits a HANDOVER SUCCESSmessage (which carries the target cell ID) to notify the source NG-RAN node at step 301. The source NG-RAN node performs the SN status transfer to the candidate NG-RAN node 1 at step 302. After performing the path switch procedure at step 303, the candidate NG-RAN node 1 transmits a UE CONTEXT RELEASE message to the source NG-RAN node at step 306. In response to receiving the UE CONTEXT RELEASE message, the source NG-RAN node releases the LTM configuration of the UE with respect to a source cell. For example, in a non-subsequent LTM configuration, after the UE accesses the target cell and executes the LTM once, the resources of other candidate cells need to be released. Optionally, in a subsequent LTM configuration, if the source cell is not used as a candidate cell, the resource of the source cell needs to be released. Thus, after the source NG-RAN node receives the LTM failure report information (optionally, reuses a HANDOVER REPORTmessage to carry LTM failure report related information), the LTM configuration information may have been released at the side of the source NG-RAN node. Since the object to be optimized at the source NG-RAN node after the LTM failure report information is obtained is related to the LTM configuration, it is undesirable that the LTM configuration information is released. The aforementioned HANDOVER SUCCESS message, the UE CONTEXT RELEASE message and/or the HANDOVER REPORT message may be an Xnap message.

FIGS. 6A, 6B and 6C illustrate exemplary embodiments for inter NG-RAN node LTM a scenario that are similar to the embodiment of FIGS. 5A, 5B and 5C, respectively.

FIG. 6A illustrates an embodiment in which the LTM configuration is stored by the UE. With respect to the LTM configuration, since the UE is already configured by the NG-RAN node through the RRCReconfiguration message at an LTM resource configuration preparation stage, there is the configuration information at the side of the UE. Since the UE knows that the radio link failure occurs, it is possible to define the action of the UE as: containing the LTM configuration information in an rlf report IE when the rlf report is generated in the situation of the radio link failure. An NG-RAN node (a candidate NG-RAN node 2 or another NG-RAN node) selected by the UE requests the UE to report the information through a UE information request message (carrying an rlf report request IE) at step 307. In response to receiving the UE information request message (carrying the rlf report request IE), the UE reports the information to the NG-RAN node through a UE information response message (carrying the rlf report IE) at step 308.

At step 309, the NG-RAN node transmits a failure indication carrying the rlf report to the candidate NG-RAN node 1. The candidate NG-RAN node 1 may perform an analysis on the cause of the failure. If the candidate NG-RAN node 1 is in an architecture in which a gNB-CU and a gNB-DU are separate, the analysis on the cause of the LTM failure may be performed by the gNB-CU or the gNB-DU using the embodiments described with reference to FIGS. 4A and 4B. For example, if the analysis needs to be performed by a candidate gNB-DU, the rlf report is carried by an AAMI message and transmitted to the candidate gNB-DU by the gNB-CU. The candidate gNB-DU generates the LTM failure report information after completing the analysis and transmits the LTM failure report information to the gNB-CU. The gNB-CU transmits an LTM failure report message or information to the source NG-RAN node. For example, the gNB-CU may reuse a HANDOVER REPORT message to carry the LTM failure report information and the rlf report IE information and transmit the LTM failure report information and the rlf report IE information to the source NG-RAN node at step 340. Although the source NG-RAN node releases the UE context, the source NG-RAN node obtains the LTM configuration when receiving the LTM failure report. Accordingly, the source NG-RAN node may perform an optimization on the LTM configuration and/or an LTM triggering strategy.

For the optimization performed by the source NG-RAN node on the LTM configuration and/or the LTM triggering strategy, the embodiment described in combination with FIGS. 5A, 5B and 5C (or FIGS. 6A, 6B and 6C) are also applicable, if the source NG-RAN node is an architecture in which a gNB-CU and a gNB-DU are separate.

Similarly to the embodiment shown in FIG. 5A (or FIG. 6A), the gNB-CU transmits the LTM failure report information and the rlf report IE information to the source gNB-DU by means of a new LTM failure report message or by reusing an F1AP AAMI message. Then, the source gNB-DU performs the optimization on the LTM configuration and/or the LTM triggering strategy.

Similarly to the embodiment shown in FIG. 5B (or FIG. 6B), after receiving the HANDOVER SUCCESS message of the candidate NG-RAN node 1 at step 301, the source NG-RAN node stops transmitting DL data to the UE and then performs later data forwarding to the candidate NG-RAN node 1. The source NG-RAN node notifies, through a sequence number status transfer message, the candidate NG-RAN node 1 of information such as a packet data convergence protocol sequence number (PDCP SN) with respect to a next allocation of the forwarded data at step 302. The SN STATUS TRANSFERmessage may be enhanced to carry the LTM configuration information, for transmitting the LTM configuration information from the source NG-RAN node to the candidate NG-RAN node 1.

The candidate NG-RAN node saves the LTM configuration information, and then transmits the HANDOVER REPORT message to the source NG-RAN node after the LTM configuration information, the LTM failure report information and the rlf report IE are carried. Accordingly, although the source NG-RAN node releases the UE context, the source NG-RAN node obtains the LTM configuration upon receiving the LTM failure report. Then, the source NG-RAN node may perform the optimization on the LTM configuration and/or the LTM triggering strategy. Optionally, the embodiment shown in FIG. 5B (or FIG. 6B) is also applicable, if the source NG-RAN node is the architecture in which the gNB-CU and the gNB-DU are separate. Specifically, the gNB-CU transmits the LTM configuration information to the source gNB-DU at step 216. Optionally, the gNB-CU transmits the LTM configuration information to the source gNB-DU by means of the new LTM failure report message or by reusing the F1AP AAMI message to carry the LTM configuration information, the LTM failure report information and the rlf report IE information, or the gNB-CU notifies the source gNB-DU of the LTM configuration information by other means. The source gNB-DU performs the optimization on the LTM configuration and/or the LTM triggering strategy based on the received information.

Similarly to the embodiment shown in FIG. 5C (or FIG. 6C), after the source NG-RAN node receives the HANDOVER SUCCESS message of the candidate NG-RAN node 1 at step 301 and completes the path switch procedure of step 303, the candidate NG-RAN node 1 transmits the UE CONTEXT RELEASE message to the source NG-RAN node at step 306. In response to receiving the UE CONTEXT RELEASEmessage, the source NG-RAN node releases the LTM configuration of the UE with respect to the source cell. The UE CONTEXT RELEASE message may be enhanced to carry an indication IE to notify the source NG-RAN node to store the LTM configuration related to the source node in the UE context. The carried indication IE may be, for example, an LTM configuration kept indicator.

Optionally, a cell ID (e.g., the CGI of a source cell) may be carried. Optionally, the embodiment shown in FIG. 5C (or FIG. 6C) is also applicable, if the source NG-RAN node is the architecture in which the gNB-CU and the gNB-DU are separate. When the gNB-CU triggers the release of the context of the source cell to the source gNB-DU, an indication IE may be carried in the message for triggering the UE CONTEXT RELEASE COMMAND or the UE CONTEXT MODIFICATION REQUEST, to notify the source gNB-DU to store the LTM configuration related to the source cell in the UE context. The carried indication IE may be, for example, an LTM configuration kept indicator. Optionally, a cell ID (e.g., the CGI of the source cell) may be carried. When the candidate NG-RAN node 1 transmits the HANDOVER REPORTmessage at step 340, the LTM failure report information and the rlf report IE information are carried to be transmitted to the source NG-RAN node. After receiving the LTM failure report and the rlf report IE information, the source NG-RAN node associates the LTM failure report and the rlf report IE information with the saved LTM configuration, and then performs the optimization on the LTM configuration and/or the LTM triggering strategy.

For an other scenario of the LTM execution to wrong cell, when a handover failure occurs before the UE successfully accesses the target cell, this failure is known to the UE, and thus, the embodiment in FIG. 5A (or FIG. 6A) is applicable and the UE may contain the LTM configuration in the rlf report. In addition, this failure is also known to the candidate NG-RAN node 1, because the source NG-RAN node, after making an LTM command, notifies the candidate NG-RAN node 1 through, for example, an Xnap message carrying the target cell ID. Therefore, if it is found that the UE does not successfully access the corresponding target cell, the candidate NG-RAN node 1 can be aware of this situation. Thus, the LTM configuration related to the source node may be saved by, for example, an Xnap message (e.g., UE Context Release) or by carrying an indication IE to inform the source NG-RAN node. The carried indication IE may be, for example, an LTM configuration kept indicator. Optionally, a cell ID (e.g., the CGI of the source cell) may be carried. The embodiments shown in FIGS. 5B and 5C (or FIGS. 6B and 6C) are applicable, if the source NG-RAN node is the architecture in which the gNB-CU and the gNB-DU are separate.

For the embodiment shown in FIG. 5C (or FIG. 6C), when the gNB-CU triggers the release of the context of the source cell to the source gNB-DU, a cell-based indication IE may be carried in the message for triggering the UE CONTEXT RELEASE COMMAND or the UE CONTEXT MODIFICATION REQUEST, to notify the source gNB-DU to store the LTM configuration related to the source cell in the UE context. The carried indication IE may be, for example, an LTM configuration kept indicator. Optionally, a cell ID (e.g., the CGI of the source cell) may be carried. For the embodiment shown in FIG. 5B (or FIG. 6B), the LTM configuration is saved by the gNB-CU. After receiving the failure indication carrying the rlf report information and transmitted by the candidate NG-RAN node 2 or another NG-RAN node, the source NG-RAN node associates the failure indication with the saved LTM configuration. If the source NG-RAN node is the architecture in which the gNB-CU and the gNB-DU are separate, the analysis on the cause of the failure may be performed by the gNB-CU or the gNB-DU. In combination with whether the LTM configuration is stored by the gNB-CU or the gNB-DU, there may be four situations as follows.

Situation 1: the gNB-DU stores the LTM configuration, and the gNB-CU analyzes the cause of failure.

According to the embodiment shown in FIG. 5C, it is assumed that the cause of the failure is analyzed by the gNB-CU, and the generated LTM failure report is transmitted to the source gNB-DU by the gNB-CU. Optionally, the gNB-CU may transmit the LTM failure report information to the source gNB-DU by means of the new LTM failure report message or by reusing the F1AP AAMI message to carry the LTM failure report information and the rlf report IE information, or the gNB-CU may notify the source gNB-DU of the LTM failure report information by other means. The source gNB-DU associates the received LTM failure report information and rlf report information with the stored LTM configuration, and then performs the optimization on the LTM configuration and/or the LTM triggering strategy.

Situation 2: the gNB-DU stores the LTM configuration, and the gNB-DU analyzes the cause of failure.

Assuming that the gNB-DU analyzes the cause of the failure, the gNB-CU may transmit the rlf report IE information to the source gNB-DU. Optionally, the gNB-CU may reuse the F1AP AAMI message to carry the rlf report IE information, and transmit the rlf report IE information to the source gNB-DU, or the gNB-CU may notify the source gNB-DU of the rlf report IE information by other means. The source gNB-DU associates the received rlf report IE information with the stored LTM configuration, and then performs the analysis on the cause of failure and the optimization on the LTM configuration and/or the LTM triggering strategy.

Situation 3: the gNB-CU stores the LTM configuration, and the gNB-CU analyzes the cause of failure.

According to the embodiment shown in FIG. 5B, it is assumed that the cause of the failure is analyzed by the gNB-CU, and the generated LTM failure report is transmitted to the source gNB-DU by the gNB-CU. Optionally, the gNB-CU may transmit the LTM failure report to the source gNB-DU by means of the new LTM failure report message or by reusing the F1AP AAMI message to carry the LTM failure report information, the rlf report IE information and the LTM configuration information, or the gNB-CU may notify the source gNB-DU of the LTM failure report by other means. Then, the source gNB-DU performs the optimization on the LTM configuration and/or the LTM triggering strategy.

Situation 4: the gNB-CU stores the LTM configuration, and the gNB-DU analyzes the cause of failure.

Assuming that the gNB-DU analyzes the cause of the failure, the gNB-CU may transmit the rlf report IE information and the LTM configuration information to the source gNB-DU. Optionally, the gNB-CU may reuse the F1AP AAMI message to carry the rlf report IE information and the LTM configuration information, and transmit the rlf report IE information and the LTM configuration information to the source gNB-DU, or the gNB-CU may notify the source gNB-DU of the rlf report IE information and the LTM configuration information by other means. Then, the source gNB-DU performs the analysis on the cause of failure and the optimization on the LTM configuration and/or the LTM triggering strategy.

In another embodiment, in the situation of too early LTM execution, regardless of the situation where the rlf occurs immediately after the UE successfully accesses the target cell and then the radio link is quickly recovered in the source cell or the situation where the handover failure occurs before the UE successfully accesses the target cell and then the radio link is quickly recovered in the source cell, it is known to the source NG-RAN node that the UE has an rlf (radio link failure) or hof (handover failure), and thus, the source NG-RAN node can store the LTM configuration by itself. Optionally, the embodiments in FIGS. 5B and 5C (or FIGS. 6B and 6C) are applicable, if the source NG-RAN node is the architecture in which the gNB-CU and the gNB-DU are separate.

For the situation where the rlf occurs immediately after the UE successfully accesses the target cell, and then the radio link is quickly recovered in the source cell, the source NG-RAN node transmits the collected rlf report to the candidate NG-RAN node through a failure indication. The cause of the LTM failure is then analyzed at the node (the candidate NG-RAN node) where the rlf occurs. If the candidate NG-RAN node is the architecture in which the gNB-CU and the gNB-DU are separate, the analysis on the cause of the LTM failure may be performed by the gNB-CU or the gNB-DU according to the embodiments described in combination with FIGS. 4A and 4B. For example, if the analysis needs to be performed by a candidate gNB-DU, the rlf report is carried by an AAMI message and transmitted to the candidate gNB-DU by the gNB-CU. The candidate gNB-DU needs to transmit the LTM failure report information to the gNB-CU after generating the LTM failure report information after the analysis. The gNB-CU then transmits the LTM failure report message or information to the source NG-RAN node.

For example, the HANDOVER REPORTmessage may be reused to carry the LTM failure report information and the rlf report IE information and then transmitted to the source NG-RAN node. The source NG-RAN node may associate the LTM failure report with the LTM configuration upon receiving the LTM failure report, and then performs the optimization on the LTM configuration and/or the LTM triggering strategy. If the source NG-RAN node is the architecture in which the gNB-CU and the gNB-DU are separate, and the LTM configuration is stored by the gNB-CU, the gNB-CU associates the received LTM failure report information and rlf report IE information with the LTM configuration to transmit the LTM failure report information, the rlf report IE information and the LTM configuration to the gNB-DU, and then the gNB-DU performs the optimization on the LTM configuration and/or the LTM triggering strategy. If the LTM configuration is stored by the gNB-DU, the gNB-CU transmits the received LTM failure report information and rlf report IE information to the gNB-DU, and then the gNB-DU associates the LTM failure report information and the rlf report IE information with the LTM configuration to perform the optimization on the LTM configuration and/or the LTM triggering strategy.

For the situation where the handover failure occurs before the UE successfully accesses the target cell and then the radio link is quickly recovered in the source cell, the source NG-RAN node analyzes the collected rlf report and then associates the analyzed rlf report with the LTM configuration, and then, the source NG-RAN node performs the optimization on the LTM configuration and/or the LTM triggering strategy. If the candidate NG-RAN node is the architecture in which the gNB-CU and the gNB-DU are separate, the analysis on the cause of the LTM failure may be performed by the gNB-CU or the gNB-DU. In combination with whether the LTM configuration is stored by the gNB-CU or the gNB-DU, the above four situations are still applicable.

In an other embodiment, in the situation of too late LTM execution, regardless of that the UE selects an LTM candidate cell or an other cell (a non-candidate cell) during the cell selection to recover the radio link connection, it is known to the source NG-RAN node that the UE has an rlf, and thus, the source NG-RAN node can store the LTM configuration by itself. The NG-RAN node accessed by re-establishing the connection transmits the collected rlf report to the source NG-RAN node through the failure indication, and then the source NG-RAN node analyzes the cause of the LTM failure and associates the analyzed cause with the stored LTM configuration. Then, the source NG-RAN node performs the optimization on the LTM configuration and/or the LTM triggering strategy. If the source NG-RAN node is the architecture in which the gNB-CU and the gNB-DU are separate, the analysis on the cause of the failure may be performed by the gNB-CU or the gNB-DU. In combination with whether the LTM configuration is stored by the gNB-CU or the gNB-DU, the above four situations are still applicable.

The mobility-related LTM configuration information mentioned in each of the above embodiments may contain one or more of the following information.
LTM candidate cell list: containing each candidate cell ID, the maximum number of candidate cells in the list being maxNrofCellsLTM-r18. Optionally, the LTM candidate cell list may be represented by an ltm-CandidateIdList or an LTM configuration ID mapping list.
LTM candidate cell ID: the LTM candidate cell ID may be represented by the CGI of an NR cell, containing ID information of each LTM candidate cell. Optionally, a corresponding LTM candidate cell ID may be represented by an LTM-CandidateId or an LTM configuration ID, because there is a corresponding mapping relationship among the three.
LTM source cell ID: the LTM source cell ID may be represented by the CGI of an NR cell. Optionally, a corresponding LTM source cell ID may be represented by an LTM-CandidateId or an LTM configuration ID, because there is a corresponding mapping relationship among the three if the source cell is also used as a candidate cell in the subsequent LTM configuration.
LTM CSI resource configuration (LTM-CSI-ResourceConfig): corresponding to configuration information of one or more CSI resources of one or more LTM candidate cells with respect to an LTM measurement and being contained in ltm-CSI-ResourceConfigToAddModList in LTM-Config IE defined in 3GPP standard specification TS 38.331. Optionally, the ltm-CSI-ResourceConfigToAddModList may configure a plurality of LTM-CSI-ResourceConfigs, and all the LTM CSI resource configurations may be represented by the ltm-CSI-ResourceConfigToAddModList.
LTM CSI report configuration (LTM-CSI-ReportConfig): corresponding to configuration information for performing a corresponding measurement report on one or more CSI resources (i.e., corresponding to one LTM CSI resource configuration) of one or more LTM candidate cells with respect to an LTM measurement, and being contained in LTM-CSI-ReportConfigToAddModList in CSI-MeasConfig in ServingCellConfig in CellGroupConfig 1E defined in 3GPP standard specification TS 38.331. Optionally, the Itm-CSI-ReportConfigToAddModList may configure a plurality of LTM-CSI-ReportConfigs, and all the LTM CSI report configurations may be represented by the ltm-CSI-ReportConfigToAddModList.

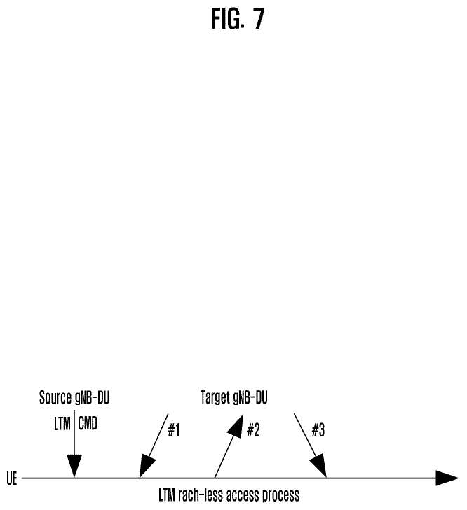

FIG. 7 illustrates a rach-less access procedure in an LTM procedure according to an exemplary embodiment of the present disclosure. When a UE receives a cell switch command transmitted by a source gNB-DU, and when the cell switch command carries the TA value of a target cell, the UE is instructed to perform the rach-less access procedure. The rach-less access procedure includes the following three steps.

At step #1, when receiving the cell switch command, the UE monitors physical downlink control channel (PDCCH) dynamic scheduling from the target cell.

At step #2, the target cell senses the arrival of the UE based on reception of the first UL transmission from this UE. The content of a first UL medium access control (MAC) protocol data unit (PDU)/transmission from the UE may be, for example, RRCReconfigurationComplete, to indicate the arrival of the UE. No new signaling needs to be introduced to indicate the arrival of the UE.

At step #3, after the target cell receives a first UL data, the UE determines whether the first UL data of the UE is successfully received by receiving PDCCH scheduling addressed with the C-RNTI of the UE in a new data transmission in the target cell.

After the UE successfully completes the above three steps, it represents that the UE successfully accesses to the target cell through the rach-less procedure.

The TA value of the target cell is acquired as follows. The UE transmits a preamble to the target cell after receiving a PDCCH command of the source gNB-DU, and then the candidate gNB-DU calculates the TA value and then transmits the TA value to the source gNB-DU through the gNB-CU. The acquisition may be implemented with reference to steps 13-15 in the normal LTM procedure shown in FIG. 3. The validity of the TA value of the target cell is determined by the source gNB-DU. If the source gNB-DU determines that the TA value of the target cell is valid when the LTM cell switch command is triggered, the TA value is carried in the LTM cell switch command. The UE then performs the rach-less access procedure on the target cell based on the TA value. However, the determination of the validity of the TA by the source gNB-DU may be inaccurate. In other words, after the UE receives the LTM cell switch command, the TA value may become invalid when the UE monitors the PDCCH dynamic scheduling procedure on the target cell, and then the rach-less access procedure may fail. In this situation, the UE initiates a normal rach-based access. According to an exemplary embodiment, in order to prevent the UE from initiating the normal rach-based access only after a rach-less failure, when the target cell determines that the TA value of the target cell is invalid in the rach-less procedure, at step #1, it is possible to instruct, by means of downlink control information (DCI), the UE to directly fall back to the rach-based access, rather than continue the rach-less procedure.

For example, when the target gNB-DU receives the CU-DU CELL SWITCH NOTIFICATION at step 20 in the normal LTM procedure shown in FIG. 3, and it is detected that the TAT timer expires or the TA value of the target cell is invalid in the rach-less procedure, in the PDCCH dynamic scheduling of step #1 in the LTM rach-less access procedure shown in FIG. 7, it is possible to carry an indicator (e.g., fallbackToRachAccess) by means of DCI (e.g., with 1 bit) to instruct the UE to directly fall back to the rach-based access, so as to avoid a fallback after the failure of the rach-less procedure, such that the UE can successfully access the target cell more quickly, thereby reducing the interrupt latency of service.

In the LTM handover procedure, the UE may access the target cell in a rach-based or rach-less access procedure. Therefore, the situation where the UE fails to access the target cell may be due to a failure in the rach-based or rach-less access procedure accordingly. According to an exemplary embodiment, to distinguish a radio link failure or a random access (RA) procedure caused by the failure in the rach-based or rach-less access procedure, the RA-Report-r16 IE reported by the UE may be enhanced to indicate that the RA procedure of the UE is performed after the failure of the LTM in the rach-less access procedure. For example, it is possible to indicate the raPurpose (RA cause) in the RA-Report-r16 IE as ltmRachlessFailure (indicating that the RA procedure is due to the rach-less access failure occurring in the LTM procedure).

In the above three steps of the rach-less access procedure with respect to the LTM, from the side of the UE, a possible failure occurs at step 1 (dynamic grant being not received) or step 3 (uplink scheduling of a new transmission being not received), and the entire rach-less access procedure fails because the UE does not receive the dynamic grant or the uplink scheduling of the new transmission. Thus, in an exemplary embodiment, the raPurpose may be newly introduced in the RA-Report-r16 IE to be ltmFailure (LTM failure) or ltmRachlessFailure (LTM rach-less failure) and/or TA invalidation. Further, the additional detail information of the ltmRachlessFailure in the UE report may also be enhanced, e.g., dynamic grant being not received or uplink (ul) scheduling of the new transmission being not received, as well as other information about a TA invalidation indication or TA value (invalid TA value and/or actual TA value), so as to perform a more targeted and more quick subsequent optimization on the LTM rach-less.

For the situation of the LTM failure of the UE, the UE generates rlf report information. If the failure of the UE occurs in the rach-less or rach-based access procedure, that is, the failure is a handover failure, when the rlf report IE is generated, the content reported by the UE may be enhanced to be for the LTM failure. For example, one or more of the following LTM failure-related information may be contained in the rlf-Report-r16 IE:
Source cell information (source cell info): including the cell ID/CGI of the source cell and the layer 1 measurement result;
Target cell information (target cell info): including the cell ID/CGI of the target cell and the layer 1 measurement result;
Neighbor cell(s) information (neighbor cells info): including the cell ID/CGI of the neighbor cell(s) and the layer 1 measurement result;
LTM candidate cell(s) information (LTM candidate cell info): information of LTM candidate cell(s) configured by the gNB-CU for the UE, including the cell(s) ID/CGI and the layer 1 measurement result;
LTM cell ID (Itm Cell Id): the CGI of an LTM candidate cell selected by the UE for fast recovery after an rlf or hof;
Last handover type being LTM (last HO-Type=ltm), where, optionally, the last handover type may further indicate a rach-less access failure, TA value invalidation, or a rach-based access failure; and
Information on rach-less access failure, e.g., no dynamic grant being received, no uplink scheduling of a new transmission being received, and/or a TA invalidation indication or TA value (invalid TA value and/or actual TA value).
Another embodiment relates to the use of a T304 timer. Currently, RAN2 has defined the reuse of a conventional T304 timer for supervising an LTM cell handover access procedure. It is being studied whether to add a new value to adapt to the rach-less access procedure. However, one timer can only configure one value. Moreover, in the LTM cell handover procedure, the UE may perform the rach-based access procedure or the rach-less access procedure. The access times of the two procedures are significantly different, and the access time of the rach-less procedure is shorter than that of the rach-based procedure. If the timer value is configured for the rach-less procedure, but the TA value of the target cell selected in deciding the LTM cell switch command is invalid, the TA value of the target cell may not be carried in the LTM cell switch command by the source gNB-DU.

Accordingly, the UE actually performs the rach-based access procedure. As a result, it may lead to a premature declaration of the LTM access failure due to the expiration of the timer in the actually performed rach-based access procedure due to the configuration of the short timer value applicable to the rach-less procedure. Similarly, if the timer value applicable to the rach-based procedure is configured but the UE actually performs the rach-less access, then when the rach-less access failure occurs, it is required to wait a long time (i.e., the timer expires) before the declaration of the LTM access failure, and then perform a cell selection to quickly recover the radio connection. In either situation, the procedure performed by the LTM is adversely affected. To avoid this problem, the present disclosure provides the following alternative schemes.

According to an embodiment, a new timer is configured for the UE only for the UE rach-less access procedure. The conventional T304 still monitors the rach-based access procedure. Both timer values are configured for the UE. The corresponding timer value is applied according to the type of the access procedure actually performed by the UE.

According to another embodiment, a timer value is configured for one type of access procedures, and a comparison relationship between the rach-less timer value and the rach-based timer value is defined. For example, the UE is configured with a timer value for the rach-less access procedure, and then it is defined that increasing the timer value by a certain offset time (Delta time) is used for the rach-based access procedure. Optionally, the UE is configured with a timer value for the rach-based access procedure, and then it is defined that reducing the timer value by a certain Delta time is used for the rach-less access procedure. In this way, in the situation where only one timer value applicable to one of the access procedures is provided, the UE may be indirectly configured with a timer applicable to the other access procedure.

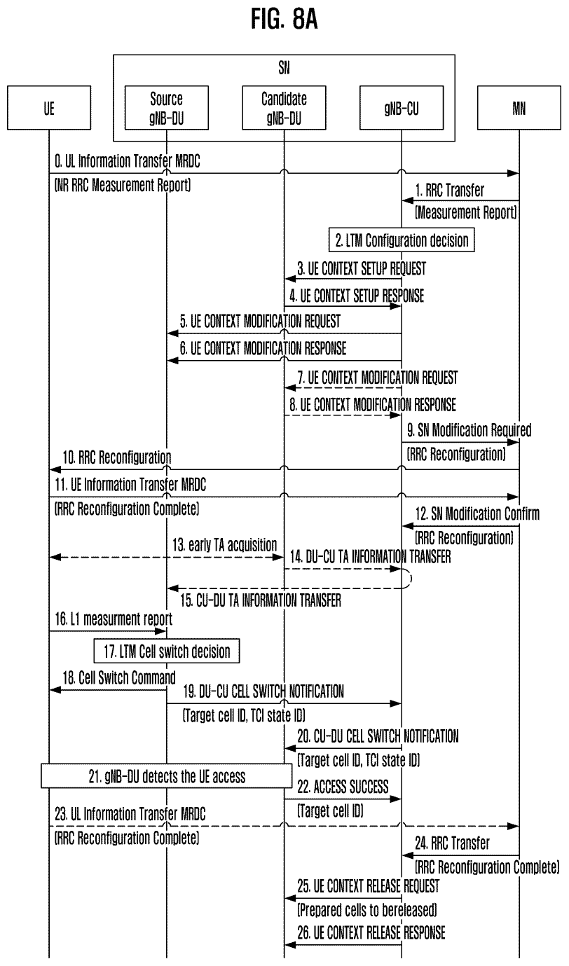

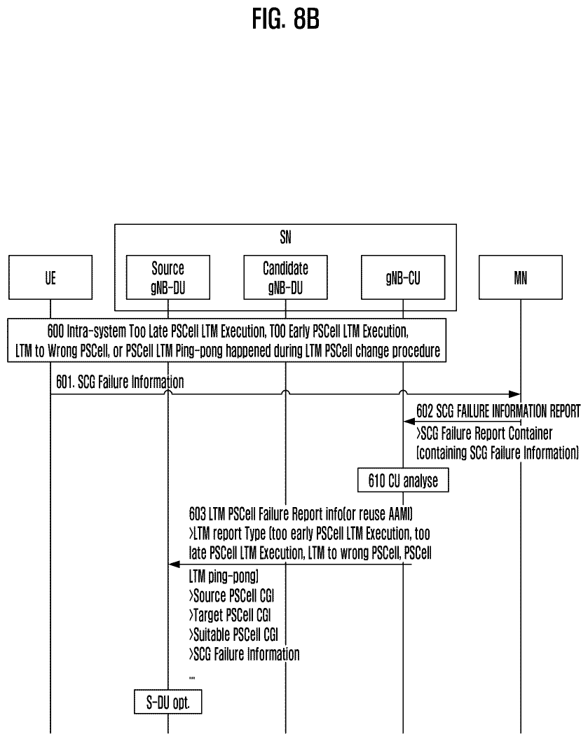

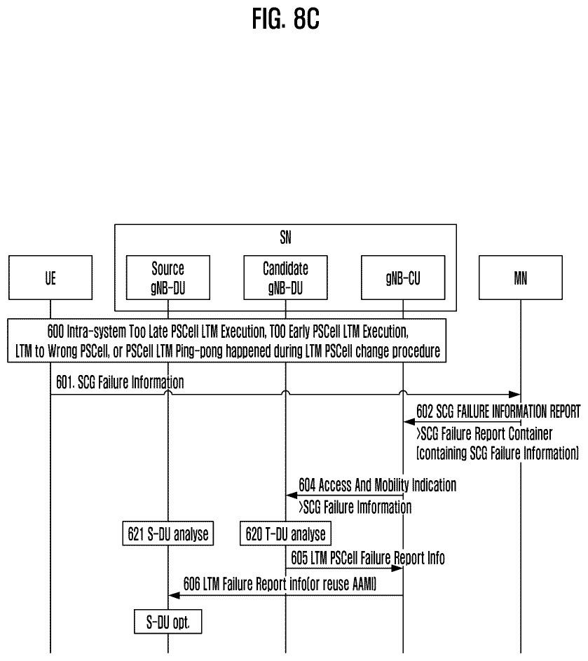

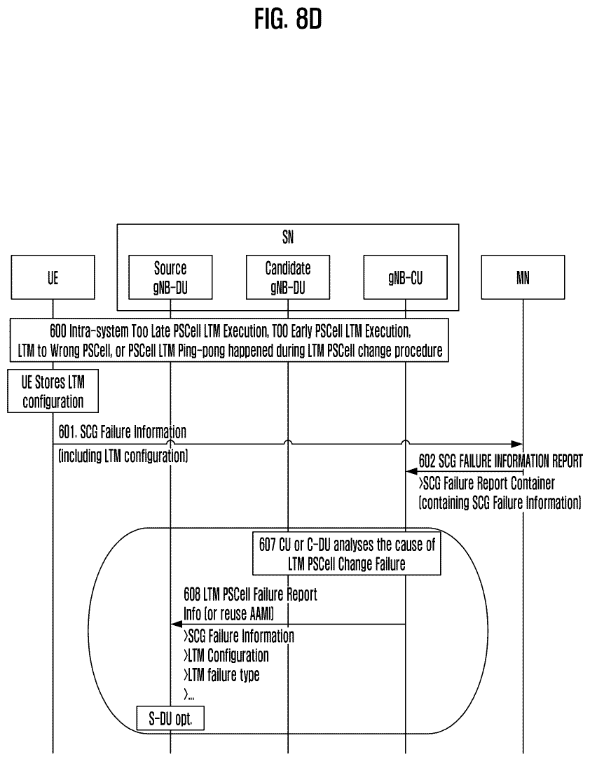

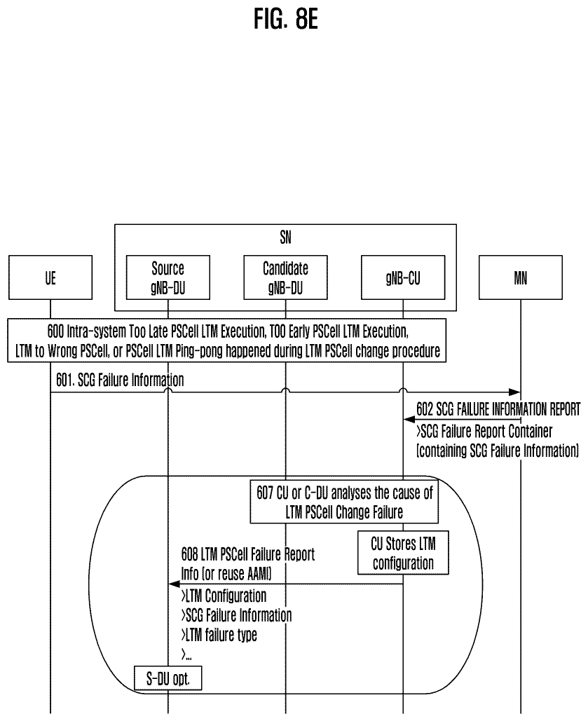

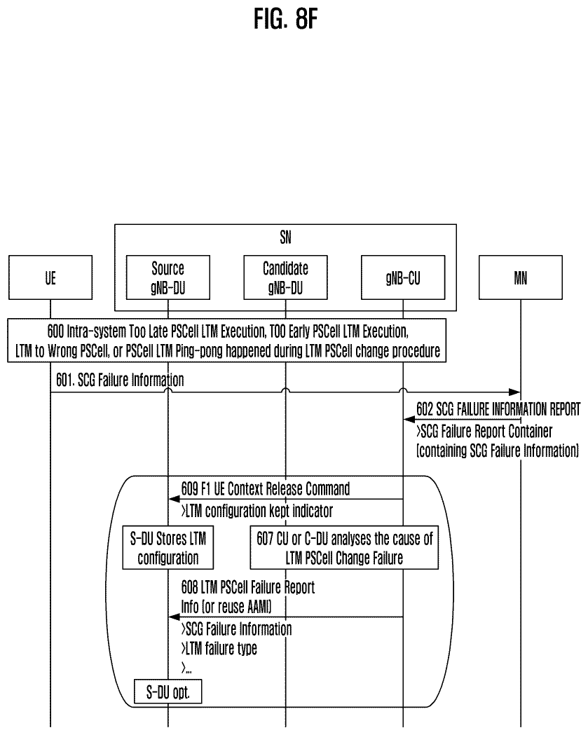

FIGS. 8A-8F illustrate flowcharts of an LTM procedure in an NR (new radio) DC (dual connection) scenario according to an exemplary embodiment of the present disclosure. This embodiment is for a scenario where a PSCell (a primary secondary cell in a secondary cell group) changes in an intra SN gNB-CU inter SN gNB-DU LTM procedure in an NR-DC (NR-NR dual connection) environment. FIG. 8A shows a flowchart of a normal LTM procedure in this scenario. In this scenario, if a signaling radio bearer 1 (signaling radio bearer #1, SRB1) is used, the UE transmits a UL information transfer multi-RAT dual connectivity (MRDC) message to a main node (MN) at step 0, the message containing an NR RRC measurement report. The MN transmits an RRC transfer message containing a measurement report to a secondary node (SN) gNB-CU at step 1. If a signaling radio bearer 3 (signaling radio bearer #3, SRB3) is used, the UE directly transmits the NR RRC measurement report to the SN, that is, the UE and the SN can directly exchange an NR RRC message therebetween without forwarding the NR RRC message to the SN through the main node (MN). The steps 2-26 of the LTM procedure in this scenario correspond to the steps 2-26 in the embodiment of FIG. 3, and thus will not be repeatedly described here. In this scenario, a mobility-related optimization is also required if an LTM PSCell change failure occurs. The present disclosure involves the following types of the LTM PSCell change failure:
Too late PSCell LTM execution. The UE receives the LTM configuration, while a secondary cell group (SCG) failure occurs before an LTM PSCell change is executed. Based on the measurement report from the UE, a suitable PSCell different from a source PSCell is found; and
Too early PSCell LTM execution. The LTM PSCell change execution is not successful, or the SCG (secondary cell group) failure occurs shortly after the LTM PSCell change execution is successful. Based on the measurement report from the UE, the source PSCell is still a suitable PSCell.

LTM execution to wrong PSCell. The LTM PSCell change execution is not successful, or the SCG failure occurs shortly after the LTM PSCell change execution is successful. Based on the measurement report from the UE, a suitable PSCell different from the source PSCell and a target PSCell is found.

This situation includes two sub-situations:
if the suitable PSCell is one of the candidate target PSCells provided by the node (SN gNB-CU) initiating the LTM, but is not one of the candidate PSCells selected by the candidate or target gNB-DU, this situation is a target PSCell selection error at the candidate or target gNB-DU;
otherwise, this situation is a wrong candidate PSCell list selection at the node (SN gNB-CU) initiating the LTM, and it is required to perform an optimization on a mobility-related LTM configuration and/or an LTM triggering strategy at the side of the gNB-CU; or it is required to perform the optimization on the mobility-related LTM configuration and/or the LTM triggering strategy at the side of the source gNB-DU.

In the above description, the successful LTM execution refers to the UE state. That is, the successful completion of the RA procedure for UE is the successful LTM execution.

FIGS. 8B and 8C illustrate flowcharts of a failure analysis and report during an LTM PSCell change according to an exemplary embodiment of the present disclosure. Referring to FIGS. 8B and 8C, an LTM PSCell change failure is transmitted at step 600. In this situation, the UE reports SCG failure information to the MN (main node) at step 601 (in the situation where the SRB1 is used), and then the MN transmits an SCG failure information report message carrying the SCG failure information to the source SN at step 602.

For a PSCell change in an intra gNB-SN inter gNB-DU LTM procedure, if the suitable PSCell is one of the candidate PSCells provided by the SN gNB-CU during LTM preparation, but is not one of the candidate PSCell selected by the target gNB-DU, the MN transmits the SCG failure information report message to the source SN gNB-CU, the message carrying the SCG failure information from the UE. The SN gNB-CU transmits an F1AP message carrying the SCG failure information to the SN gNB-DU to perform an analysis on the LTM PSCell change failure.

When the LTM PSCell change failure occurs, the UE reports the SCG failure information to the MN (in the situation where the SRB1 is used), and then the MN transmits the SCG failure information report message to the source SN, the message carrying the SCG failure information from the UE. The UE may directly transmit the SCG failure information to the SN (in the situation where the SRB3 is used). Optionally, the analysis on the cause of the LTM PSCell change failure is performed by the SN gNB-CU, or by the source gNB-DU or a last serving candidate gNB-DU. Finally, the analyzed LTM failure report information is transmitted to the source gNB-DU for corresponding optimization.

In order to perform the analysis on the cause of the LTM failure and the optimization, in the SCG failure information message reported by the UE, it is possible to report one or more of the following information related to the LTM PSCell change failure:
Failure type (failureType): being able to indicate that the type is an LTM failure (representing the rach-based access failure or rach-less access failure of the UE), or an LTM rach-less failure (representing the rach-less access failure of the UE), or an LTM rach failure (representing the rach-based access failure of the UE);
Source PSCell information (Source PSCell info): including the cell ID/CGI of the source PSCell and the layer 1 measurement result (L1 measurement result);
Target PSCell information (Target PSCell info): including the cell ID/CGI of the target PSCell and the layer 1 measurement result;
Neighbor PSCell(s) information (Neighbor PSCells info): including the cell ID/CGI of the neighbor PSCell(s) and the layer 1 measurement result;
LTM Candidate PSCell(s) information (LTM Candidate PSCell List): being the information of the LTM candidate PSCell(s) configured by the SN gNB-CU for the UE, and including the cell ID/CGI and the layer 1 measurement result;
LTM PSCell ID (Itm PSCell Id): being the CGI of an LTM candidate suitable PSCell selected based on the measurement reported by the UE after the rlf or hof; and
Information for the rach-less access failure, e.g., no reception of a dynamic grant, no reception of uplink scheduling of a new transmission, and/or a TA invalidation indication or TA value (invalid TA value and/or actual TA value).

In order to perform the analysis on the cause of the LTM failure and the optimization, the mechanism of performing the analysis on the cause of the LTM failure and the optimization described in the embodiments of FIGS. 4A and 4B and the enhancement for an F1 interface are also applicable in this embodiment. After the SN gNB-CU receives the UE report through the MN (in the situation where the SRB1 is used), or directly receives the UE report (in the situation where the SRB3 is used) carrying the SCG failure related information, it is possible to select the SN gNB-CU or the SN gNB-DU to analyze the cause of the LTM PSCell change failure.

For example, referring to the embodiment shown in FIG. 8B, the analysis for the cause of the LTM PSCell change failure is performed by the SN gNB-CU. Through the LTM PSCell change failure related information contained in the SCG failure information reported by the UE, the SN gNB-CU performs the analysis on the cause of the failure at step 610 and generates the LTM PSCell failure report information. Then, the SN gNB-CU transmits the LTM PSCell failure report information to the source gNB-DU at step 603. Optionally, the SN gNB-CU may transmit the LTM PSCell failure report information to the source gNB-DU by means of a new LTM PSCell failure report message or by reusing an F1AP AAMI message to carry the LTM PSCell failure report information and the SCG failure information, or the gNB-CU may notify the source gNB-DU of the LTM PSCell failure report information by other means. The source gNB-DU performs the optimization on the LTM configuration and/or the LTM triggering strategy based on the received information.

For example, referring to the embodiment shown in FIG. 8C, the analysis for the cause of the LTM PSCell change failure is performed by the SN gNB-DU (a source SN gNB-DU or a target SN gNB-DU). After receiving, from the MN, the SCG failure information reported by the UE, the SN gNB-CU may reuse the F1AP AAMI message at step 604 to carry the SCG failure information, and may carry a UE assistant identifier information (e.g., a gNB-DU UE F1AP ID), and transmit the information to the source SN gNB-DU or the target SN gNB-DU. The source SN gNB-DU performs the analysis on the cause of the failure and the optimization at step 621, or the target gNB-DU performs the analysis on the cause of the failure at step 620 to generate the LTM PSCell failure report information. According to the scenario of the LTM failure, the SN gNB-CU transmits the collected SCG failure information to the source gNB-DU or the candidate gNB-DU for analysis. For example, for the situation of too late PSCell LTM execution, the gNB-CU transmits the SCG failure information to the source gNB-DU, for the source gNB-DU to perform the analysis and the optimization on the LTM configuration and/or the LTM triggering strategy.

For the handover failure of the UE in the situation of too early PSCell LTM execution or LTM execution to Wrong PSCell, the gNB-CU may transmit the SCG failure information to the source gNB-DU, for the source gNB-DU to perform the analysis and the optimization on the LTM configuration and/or the LTM triggering strategy. For example, the gNB-CU may transmit the SCG failure information to the gNB-DU by means of a new F1AP AAMI message or by using an existing F1AP AAMI message with enhancement to carry the SCG failure information. Moreover, for the rlf occurring after the successful access of the UE to the target cell in the situation of the too early PSCell LTM execution or the LTM execution to Wrong PSCell, the gNB-CU may transmit the SCG failure information to the candidate gNB-DU for analysis. The candidate gNB-DU is the gNB-DU where the target PSCell is, and a radio link failure occurs immediately after the UE successfully accesses the target PSCell. In the embodiment of FIG. 8C, the SCG failure information may be carried by the AAMI message and transmitted by the gNB-CU to the candidate gNB-DU at step 604. The candidate gNB-DU transmits the LTM PSCell failure report information generated after the analysis to the gNB-CU at step 605, and then the gNB-CU transmits the LTM PSCell failure report information to the source gNB-DU at step 606. The source gNB-DU performs the optimization on the LTM configuration and/or the LTM triggering strategy based on the received information.

In the above process, the LTM PSCell failure report message or information generated by the gNB-CU or the LTM failure report message or information generated by performing the analysis by the candidate gNB-DU is transmitted to the gNB-CU, and then forwarded to the source gNB-DU by the gNB-CU. The LTM PSCell failure report message or information may contain one or more of the following information.
LTM report type: indicating that the failure type is too early PSCell LTM execution, too late PSCell LTM execution, LTM execution to wrong PSCell or PSCell LTM execution ping-pong. Here, the PSCell LTM execution ping-pong type may be determined by the gNB-CU according to a visited cell information list (VisitedCellInfoList) IE in a mobility history report (MobilityHistoryReport) IE reported by the UE, or according to the source cell and the target cell in which the UE resides through the LTM and the residence time known by the gNB-CU.
CGI of source PSCell: the CGI of the source PSCell for the LTM procedure in the source gNB-DU.
CGI of target PSCell: the CGI of the target PSCell for the LTM procedure in the candidate gNB-DU.
CGI of suitable PSCell: the CGI of a suitable LTM candidate PSCell obtained based on a measurement reported by the UE after the rlf or hof, this information being contained when the LTM report type is LTM to Wrong PSCell.
C-RNTI in source PSCell: the cell radio network temporary identifier allocated at the source gNB-DU, and the C-RNTI used in the source PSCell after a handover failure or a radio link failure, the C-RNTI being used to cause the source gNB-DU to query the stored UE context to match the corresponding LTM PSCell failure report.
C-RNTI in target PSCell: the cell radio network temporary identifier allocated at the target gNB-DU, and the C-RNTI used in the target cell after a radio link failure or a handover failure is detected.
C-RNTI in last serving PSCell: the cell radio network temporary identifier allocated at the last serving gNB-DU, and the C-RNTI used in the last serving cell after a radio link failure or a handover failure is detected. Through this information, the gNB-DU receiving the SCG failure information can determine whether the SCG failure information occurs on the gNB-DU without decoding the content of the SCG failure information.
SCG failure report container: the SCG failure information message defined in 3GPP standard specification TS 38.331.
TA invalidation indication: indicating that the occurrence of the rach-less access failure is due to the TA invalidity. Optionally, the TA invalidation conclusion may be obtained by comparing a TA value (carried in the cell switch command) received from the source gNB-DU and an actual TA value (performing the rach-based access after the rach-less failure).

After receiving this information, the source gNB-DU performs the optimization on the LTM configuration and/or the LTM triggering strategy based on the received information.

In order to perform the analysis on the cause of the LTM failure and the optimization, the source gNB-DU needs to perform the optimization on the LTM mobility related LTM configuration and/or the LTM triggering strategy. However, in some scenarios of the LTM failure, these LTM mobility-related parameter configurations (LTM configurations) may have been released along with the UE context. In this regard, the embodiments described in combination with FIGS. 5A-5C are also applicable. The embodiments shown in FIGS. 8D, 8E and 8F are similar to those shown in FIGS. 5A, 5B and 5C, respectively.

FIG. 8D illustrates an embodiment in which the LTM configuration is stored by the UE. With respect to the LTM configuration, since the UE is already configured by the SN gNB-CU through the RRCReconfiguration message at an LTM resource configuration preparation stage, there is the configuration information at the side of the UE. Since the UE knows that the radio link failure occurs, it is possible to define the action of the UE as containing the LTM configuration information in the SCG failure information message when the SCG failure information is generated in the situation of the LTM PSCell change failure or RLF. At step 601, the UE transmits the SCG failure information message containing the LTM configuration information to the MN. At step 602, the MN receiving the SCG failure information message transmits the SCG failure information report message containing the SCG failure information to the SN gNB-CU.

At step 607, the SN gNB-CU or the candidate gNB-DU performs the analysis on the cause of the LTM PSCell change failure. After generating the LTM PSCell failure report message or information or receiving the LTM PSCell failure report message or information generated by performing the analysis by the candidate gNB-DU, the SN gNB-CU transmits the LTM PSCell failure report message or information carrying the SCG failure information (carrying the LTM configuration) to the source gNB-DU at step 608. Then, the source gNB-DU performs the optimization on the LTM configuration and/or the LTM triggering strategy.

FIG. 8E illustrates an embodiment in which the LTM configuration is stored by the SN gNB-CU. For a situation where an rlf occurs immediately after the UE successfully accesses the target PSCell, or an other situation where an access failure occurs during an LTM PSCell change, or an other situation of the LTM PSCell change failure, since the SN gNB-CU knows that the failure occurs, it is possible to define the action of the SN gNB-CU as follows: after receiving an ACCESS SUCCESS message of the candidate gNB-DU, the SN gNB-CU stores the mobility-related LTM configuration of the source PSCell, releases the mobility-unrelated LTM configuration, and normally triggers the release of the context of the source cell to the source gNB-DU. After the SN gNB-CU obtains the SCG failure information, the analysis on the cause of the LTM failure may be performed by the gNB-CU or the gNB-DU at step 607, and the specific process is according to the embodiments of FIGS. 4A and 4B.

When generating the LTM PSCell failure report message or information, or receiving the LTM PSCell failure report message or information generated by performing the analysis by the candidate gNB-DU, the SN gNB-CU needs to transmit the LTM PSCell failure report message or information to the source gNB-DU. At this time, the stored LTM configuration information and the SCG failure information are carried and transmitted to the source gNB-DU by the SN gNB-CU at step 608. Then, the source gNB-DU performs the optimization on the LTM configuration and/or the LTM triggering strategy.

FIG. 8F illustrates an embodiment in which the LTM configuration is stored by the source gNB-DU. For the situation where the rlf occurs immediately after the UE successfully accesses the target PSCell, or the other situation where the access failure occurs during the LTM PSCell change, or the other situation of the LTM PSCell change failure, the SN gNB-CU knows that the failure occurs. When receiving the ACCESS SUCCESS message of the candidate gNB-DU, the gNB-CU may trigger a UE CONTEXT RELEASE COMMAND or a UE CONTEXT MODIFICATION REQUEST procedure to the source gNB-DU to release the configuration of the LTM of the UE at step 609. An indication IE may be carried in the message for triggering the UE CONTEXT RELEASE COMMAND or the UE CONTEXT MODIFICATION REQUEST, to notify the source gNB-DU to store the LTM configuration related to the mobility of the source cell in the UE context and release the mobility-unrelated LTM configuration. The carried indication IE may be, for example, an LTM configuration kept indicator. Optionally, a cell ID (e.g., the CGI of a source cell) may be carried.

After the SN gNB-CU obtains the SCG failure information, the analysis on the cause of the LTM PSCell failure may be performed by the gNB-CU or the gNB-DU, and the specific process is according to the embodiments of FIGS. 4A and 4B. When generating the LTM PSCell failure report message or information, or receiving the LTM PSCell failure report message or information generated by performing the analysis by the candidate gNB-DU, the SN gNB-CU needs to transmit the LTM PSCell failure report message or information to the source gNB-DU. The source gNB-DU associates the received LTM PSCell failure report information with the stored LTM configuration, and then performs the optimization on the LTM configuration and/or the LTM triggering strategy.

The mobility-related LTM configuration information mentioned in each of the above embodiments and schemes may contain one or more of the following information.
LTM candidate PSCell list: containing each candidate PSCell ID, the maximum number of candidate PSCells in the list being maxNrofPSCellsLTM. Optionally, the LTM candidate PSCell list may be represented by an ltm-CandidateIdList or an LTM configuration ID mapping list.
LTM candidate PSCell ID: the LTM candidate PSCell ID may be represented by the CGI of an NR cell, containing ID information of each LTM candidate PSCell. Optionally, a corresponding LTM candidate PSCell ID may be represented by an LTM-CandidateId or an LTM configuration ID, because there is a corresponding mapping relationship among the three.
LTM source primary secondary Cell ID (LTM Source PSCell ID): the LTM source primary secondary cell ID may be represented by the CGI of an NR cell. Optionally, a corresponding LTM source primary secondary cell ID may be represented by an LTM-CandidateId or an LTM configuration ID, because there is a corresponding mapping relationship among the three if a source secondary cell is also used as a candidate cell in the subsequent LTM configuration.
LTM CSI resource configuration (LTM-CSI-ResourceConfig): corresponding to configuration information of one or more CSI resources of one or more LTM candidate PSCells with respect to an LTM measurement and being contained in ltm-CSI-ResourceConfigToAddModList in LTM-Config IE defined in 3GPP standard specification TS 38.331. Optionally, the ltm-CSI-ResourceConfigToAddModList may configure a plurality of LTM-CSI-ResourceConfigs, and all the LTM CSI resource configurations may be represented by the ltm-CSI-ResourceConfigToAddModList.
LTM CSI report configuration (LTM-CSI-ReportConfig): corresponding to configuration information for performing a corresponding measurement report on one or more CSI resources (i.e., corresponding to one LTM-CSI-ResourceConfigs) of one or more LTM candidate PSCells with respect to an LTM measurement, and being contained in LTM-CSI-ReportConfigToAddModList in CSI-MeasConfig in ServingCellConfig in CellGroupConfig IE defined in 3GPP standard specification TS Optionally, the Itm-CSI-ReportConfigToAddModList may configure a plurality of LTM-CSI-ReportConfigs, and all the LTM CSI report configurations may be represented by the ltm-CSI-ReportConfigToAddModList.

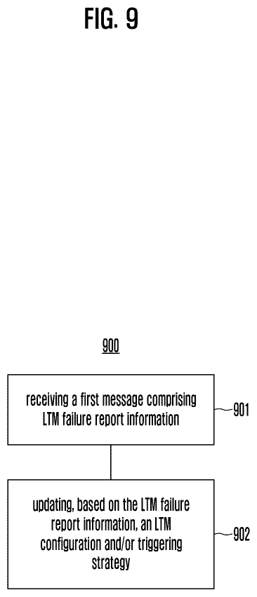

FIG. 9 illustrates a method 900 performed by a first node according to an exemplary embodiment of the present disclosure. At step 901, the first node receives a first message including LTM failure report information related to a UE. Here, the LTM failure report information is generated based on the RLF report information of the UE. At step 902, the first node updates an LTM configuration and/or triggering strategy related to the mobility of the UE based on the LTM failure report information. According to the method 900 performed by the first node, the first node may update (or optimize) the LTM configuration and/or triggering strategy related to the mobility of the UE based on the LTM failure report information related to the LTM failure of the UE, and thus, similar failures may be avoided during the subsequent LTM movement.

In an exemplary embodiment, the first node may be, for example, a source gNB-DU in an intra-gNB-CU inter-gNB-DU LTM scenario (e.g., FIGS. 4A-5C), an intra-gNB-CU intra-gNB-DU LTM scenario, or an intra SN gNB-CU inter SN gNB-DU LTM scenario (e.g., FIGS. 8A-8F) in an NR-DC environment. The LTM failure report information may include at least one of: an LTM failure type, a cell global identifier (CGI) of a source cell, the CGI of a target cell, the CGI of a re-establishment cell, the CGI of a recovery cell, a cell radio network temporary identifier (C-RNTI) of the source cell, the C-RNTI of a target cell, the C-RNTI of a last serving cell, a UE RLF report container, and a TA invalidation indication that are associated with the UE.

In an exemplary embodiment, the first node may be a source NG-RAN node in an inter NG-RAN node LTM scenario (e.g., FIGS. 6A-6C). The LTM failure report information may be associated with a secondary cell group (SCG) failure and includes at least one of: the LTM failure type, a source primary secondary cell (PSCell) CGI, the CGI of a target PSCell, the CGI of a suitable PSCell, the C-RNTI of a source PSCell, the C-RNTI of a target PSCell, the C-RNTI of a last serving PSCell, an SCG failure report container, and the TA invalidation indication that are associated with the UE.

In an exemplary embodiment, according to a different scenario, the first message may be an LTM failure report message, an LTM PSCell failure report message, an ACCESS AND MOBILITY INDICATION (AAMI) message, or an Xn application protocol (Xnap) HANDOVER REPORTmessage.

In an exemplary embodiment, the LTM failure report information may further include the LTM configuration related to the mobility of the UE, and the LTM configuration includes at least one of: an LTM candidate cell list, an LTM candidate cell ID, an LTM channel state information (CSI) resource configuration, and an LTM CSI report configuration. In this situation, even if the first node has released the UE context, the first node can obtain the LTM configuration upon receiving the LTM failure report information. Accordingly, the first node performs the optimization on the LTM configuration and/or the LTM triggering strategy.

In an exemplary embodiment, the method performed by the first node further includes: receiving a second message related to UE CONTEXT RELEASE, the second message including an LTM configuration kept indicator; and releasing an LTM configuration unrelated to the mobility of the UE according to the second message and keeping the LTM configuration related to the mobility of the UE. The LTM configuration related to the mobility of the UE may include, for example, at least one of: the LTM candidate cell list, the LTM candidate cell ID, the LTM CSI resource configuration, and the LTM CSI report configuration. In this situation, the first node keeps the LTM configuration information related to the mobility of the UE when releasing the UE context, and thus can perform the optimization on the LTM configuration and/or the LTM triggering strategy. According to a different scenario, the second message may be, for example, an F1AP UE CONTEXT RELEASE COMMAND message, a UE CONTEXT MODIFICATION REQUEST message, or an Xnap UE CONTEXT RELEASE message.

In an exemplary embodiment, for the inter NG-RAN node LTM scenario, the method performed by the first node may further include: transmitting a message including the LTM configuration related to the mobility of the UE. Here, a previously transmitted LTM configuration may be contained in the first message received by the first node. For example, the LTM configuration includes at least one of: the LTM candidate cell list, the LTM candidate cell ID, the LTM CSI resource configuration, and the LTM CSI report configuration.

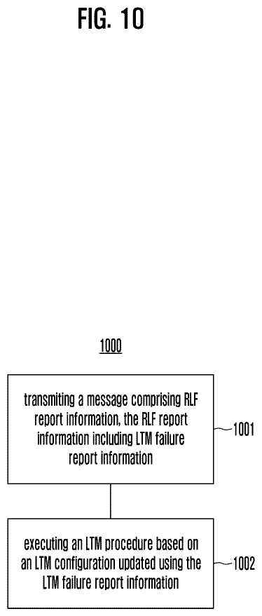

FIG. 10 illustrates a method 1000 performed by a UE according to an exemplary embodiment of the present disclosure. At step 1001, the UE transmits a message including RLF report information. Here, the RLF report information is used to generate LTM failure report information related to mobility of the UE. At step 1002, an LTM procedure is executed based on an LTM configuration updated using the LTM failure report information.

In an exemplary embodiment, the RLF report information may include an LTM configuration related to mobility of the UE. Specifically, the LTM configuration may include at least one of: an LTM candidate cell list, an LTM candidate cell ID, an LTM channel state information (CSI) resource configuration, and an LTM CSI report configuration.

In an exemplary embodiment, the RLF report information may include LTM failure-related information. Specifically, the LTM failure-related information may include at least one of: source cell information, target cell information, neighbor cell information, LTM candidate cell information, LTM cell information, last handover type information, information indicating a rach-based access failure or a rach-less access failure, and information on the rach-less access failure. Optionally, in the intra SN gNB-CU inter SN gNB-DU LTM scenario in an NR-DC environment, the LTM failure-related information is associated with the secondary cell group (SCG) failure, and includes at least one of: an LTM failure type, source primary secondary cell (PSCell) information, target PSCell information, neighbor PSCell information, an LTM candidate PSCell list, an LTM PSCell identifier, the information indicating the rach-based access failure or rach-less access failure, and the information on the rach-less access failure. Specifically, at least one of the source cell information, the target cell information, the neighbor cell information, the LTM candidate cell information, the LTM cell information, the source PSCell information, the target PSCell information and the neighbor PSCell information may include, for example, the CGI of the cell and L1 measurement result of a corresponding cell.

In an exemplary embodiment, the LTM failure report information includes the LTM configuration related to the mobility of the UE. Here, the LTM configuration includes at least one of: the LTM candidate cell list, the LTM candidate cell ID, the LTM CSI resource configuration, and the LTM CSI report configuration.

In an exemplary embodiment, the LTM failure report information includes at least one of: the LTM failure type, a cell global identifier (CGI) of a source cell, the CGI of a target cell, the CGI of a re-establishment cell, the CGI of a recovery cell, a cell radio network temporary identifier (C-RNTI) of the source cell, the C-RNTI of a target cell, the C-RNTI of a last serving cell, a UE RLF report container, and a TA invalidation indication that are associated with the UE. Optionally, in the intra SN gNB-CU inter SN gNB-DU LTM scenario in the NR-DC environment, the LTM failure report information is associated with the secondary cell group (SCG) failure, and includes at least one of: the LTM failure type, a source primary secondary cell (PSCell) CGI, the CGI of a target PSCell, the CGI of a suitable PSCell, the C-RNTI of a source PSCell, the C-RNTI of a target PSCell, the C-RNTI of a last serving PSCell, an SCG failure report container, and the TA invalidation indication that are associated with the UE.

In an exemplary embodiment, the information on the rach-less access failure includes at least one of: information on no reception of a dynamic grant, information on no reception of uplink scheduling of a new transmission, and information on an invalid TA value and/or actual TA value. In an exemplary embodiment, the method performed by the UE further includes: receiving, during a rach-less access, an indication of a fallback to a rach-based access; and terminating the rach-less access and performing the rach-based access, in response to the received indication. Optionally, the rach-less access failure is determined based on a timer value configured for the rach-less access, or based on a timer value configured for the rach-based access and an offset value configured for the rach-less access.

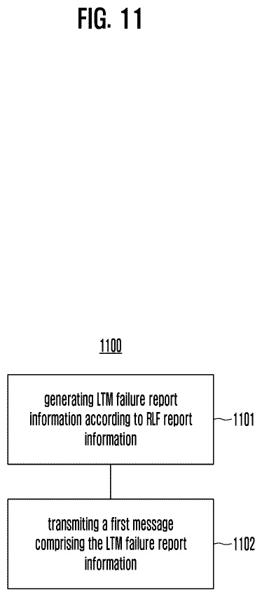

FIG. 11 illustrates a method 1100 performed by a second node according to an exemplary embodiment of the present disclosure. At step 1101, the second node generates LTM failure report information according to RLF report information of a UE. At step 1102, the second node transmits a first message including the LTM failure report information. The LTM failure report information is used to update the LTM configuration and/or triggering strategy related to the mobility of the UE.

In an exemplary embodiment, a first node may be, for example, a gNB-CU or a candidate gNB-DU in an intra-gNB-CU inter-gNB-DU LTM scenario (e.g., FIGS. 4A-5C), an intra-gNB-CU intra-gNB-DU LTM scenario, or an intra SN gNB-CU inter SN gNB-DU LTM scenario (e.g., FIGS. 8A-8F) in an NR-DC environment. The LTM failure report information may include at least one of: an LTM failure type, a cell global identifier (CGI) of a source cell, the CGI of a target cell, the CGI of a re-establishment cell, the CGI of a recovery cell, a cell radio network temporary identifier (C-RNTI) of the source cell, the C-RNTI of a target cell, the C-RNTI of a last serving cell, a UE RLF report container, and a TA invalidation indication that are associated with the UE.

In an exemplary embodiment, the second node may be a candidate NG-RAN node in an inter NG-RAN node LTM scenario (e.g., FIGS. 6A-6C). The LTM failure report information may be associated with a secondary cell group (SCG) failure and includes at least one of: the LTM failure type, a source primary secondary cell (PSCell) CGI, the CGI of a target PSCell, the CGI of a suitable PSCell, the C-RNTI of a source PSCell, the C-RNTI of a target PSCell, the C-RNTI of a last serving PSCell, an SCG failure report container, and the TA invalidation indication that are associated with the UE.

In an exemplary embodiment, according to a different scenario, the first message may be an LTM failure report message, an LTM PSCell failure report message, an ACCESS AND MOBILITY INDICATION (AAMI) message, an Xn application protocol (Xnap) HANDOVER REPORTmessage, or an Xnap FAILURE INDICATIONmessage.

In an exemplary embodiment, a gNB-CU as the second node receives a message including the RLF report information from the UE, the RLF report information including at least one of the LTM configuration related to the mobility of the UE or LTM failure-related information. As an example, the LTM configuration includes at least one of: an LTM candidate cell list, an LTM candidate cell ID, an LTM channel state information (CSI) resource configuration, and an LTM CSI report configuration. As an example, the LTM failure-related information includes at least one of: source cell information, target cell information, neighbor cell information, LTM candidate cell information, LTM cell information, last handover type information, information indicating a rach-based access failure or a rach-less access failure, and information on the rach-less access failure.

Optionally, as an example, the LTM failure-related information is associated with the secondary cell group (SCG) failure, and includes at least one of: the LTM failure type, source primary secondary cell (PSCell) information, target PSCell information, neighbor PSCell information, an LTM candidate PSCell list, an LTM PSCell identifier, the information indicating the rach-based access failure or rach-less access failure, and the information on the rach-less access failure. The information on the rach-less access failure may include at least one of: information on no reception of a dynamic grant, information on no reception of uplink scheduling of a new transmission, and information on an invalid TA value and/or actual TA value.

In an exemplary embodiment, the LTM failure report information includes the LTM configuration related to the mobility of the UE, and the LTM configuration includes at least one of: the LTM candidate cell list, the LTM candidate cell ID, the LTM CSI resource configuration, and the LTM CSI report configuration.

In an exemplary embodiment, the second node may further transmit, to the first node, a second message related to UE CONTEXT RELEASE, the second message including an LTM configuration kept indicator. As an example, the LTM configuration kept indicator is used to indicate that the first node keeps the LTM configuration related to the mobility of the UE while releasing an LTM configuration unrelated to the mobility of the UE. The LTM configuration related to the mobility of the UE includes at least one of: the LTM candidate cell list, the LTM candidate cell ID, the LTM CSI resource configuration, and the LTM CSI report configuration. In an exemplary embodiment, the second message may refer to an F1 application protocol (F1 AP) UE CONTEXT RELEASE COMMAND message, a UE CONTEXT MODIFICATION REQUEST message, or an Xnap UE CONTEXT RELEASE message.

In an exemplary embodiment, the second node may further receive and store a message of the LTM configuration related to the mobility of the UE. Here, the LTM configuration includes at least one of: the LTM candidate cell list, the LTM candidate cell ID, the LTM CSI resource configuration, and the LTM CSI report configuration. Here, a previously received and stored LTM configuration is contained in the first message to be transmitted. The message of the LTM configuration related to the mobility of the UE is, for example, a sequence number (SN) status transfer message.

In an exemplary embodiment, the candidate gNB-DU as the second node may determine that the UE may have a rach-less access failure; and transmit an indication of a fallback to a rach-based access to the UE. For example, it is determined that the UE may have the rach-less access failure on the basis that the TA value of the target cell configured for a rach-less access is invalid or a TAT timer expires. The second node determines that the UE may have the rach-less access failure; and transmit the indication of the fallback to the rach-based access to the UE.

The methods performed by the nodes according to embodiments of the present disclosure are described above. It should be understood that each the nodes performing the corresponding methods are also included within the scope of the present disclosure.

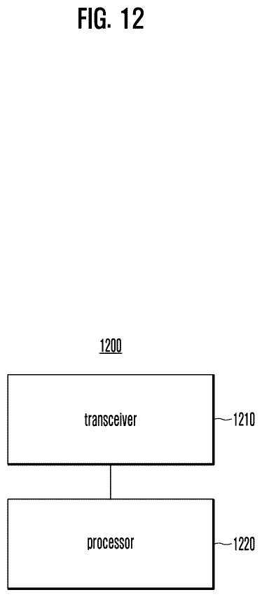

FIG. 12 illustrates an exemplary structure of each node according to exemplary embodiment of the present disclosure. The exemplary node shown in FIG. 8 includes a transceiver 1210 and a processor 1220 coupled to the transceiver 1210. The transceiver 1210 is configured to transmit and receive a signal. The processor 1220 is configured to perform the method described in the present disclosure. The present disclosure may be implemented as a computer storage medium. The computer storage medium stores computer executable instructions. When the stored computer executable instructions are executed by the processor, the processor performs the method described in the present disclosure.

The various illustrative logical blocks, modules, and circuits described in the present disclosure may be implemented or performed with a general purpose processor, a digital signal processor (DSP), an application specific integrated circuit (ASIC), a field programmable gate array (FPGA) or other programmable logic devices, a discrete gate or transistor logic, a discrete hardware component, or any combination thereof designed to perform the functions described herein. The general purpose processor may be a microprocessor, but in an alternative scheme, the processor may be any conventional processor, controller, microcontroller, or state machine. The processor may be implemented as a combination of computing devices, for example, a combination of a DSP and a microprocessor, a plurality of microprocessors, one or more microprocessors in collaboration with a DSP core, or any other such configuration.

The steps of the method or algorithm described in the present disclosure may be embodied directly in hardware, in a software module executed by the processor, or in a combination of the two. The software module may reside in a RAM memory, a flash memory, a ROM memory, an EPROM memory, an EEPROM memory, a register, a hard disk, a removable disk, or any other form of storage medium known in the art. An exemplary storage medium is coupled to the processor, to enable the processor to read information from/write information to the storage medium. In an alternative scheme, the storage medium may be integrated to the processor. The processor and the storage medium may reside in an ASIC. The ASIC may reside in a user terminal. In an alternative scheme, the processor and the storage medium may reside as discrete components in a user terminal.

In one or more exemplary designs, the functions described may be implemented in hardware, software, firmware, or any combination thereof. If implemented in software, the functions may be stored on or transmitted over a computer readable medium as one or more instructions or codes. The computer readable medium includes both a computer storage medium and a communication medium, the communication medium including any medium that facilitates the transfer of a computer program from one place to another. The storage medium may be any available medium that can be accessed by a general purpose or special purpose computer.

Example methods and apparatuses are described in combination with the accompanying drawings in description set forth herein, and do not represent all the examples that may be implemented or that are within the scope of the claims. The term “example” used herein means “serving as an example, instance, or illustration,” rather than “preferred” or “advantageous over other examples.” The detailed description includes specific details for the purpose of providing an understanding of the described techniques. These techniques, however, may be practiced without these specific details. In some cases, well-known structures and devices are shown in the form of a block diagram in order to avoid obscuring the concepts of the described examples.

This specification contains many specific implementation details, but the implementation details should not be construed as a limitation to the scope of any disclosure or the scope claimed, but rather as a description for specific features in a specific embodiment of the specific disclosure. Certain features described in the context of separate embodiments in this specification may be implemented in combination in a single embodiment. Rather, the various features described in the context of a single embodiment may be implemented separately in a plurality of embodiments or implemented in any suitable sub-combination. Furthermore, the features may be described as functioning in certain combinations in the context, and even initially so claimed, but in some cases one or more features in a claimed combination may be deleted from the combination, and the claimed combination may be directed to a sub-combination or the variation of the sub-combination.

It is to be understood that the specific order or hierarchy of steps in the method in the present disclosure is an illustration for an exemplary process. Based on design preferences, it may be understood that the specific order or hierarchy of the steps in the method may be rearranged to achieve the functions and effects disclosed in the present disclosure. The accompanying method claims present the elements of various steps in example order, but are not intended to be limited to the specific order or hierarchy presented, unless specifically stated otherwise. Furthermore, although an element may be described or claimed in a singular form, the plural can also be expected unless the limitation to the singular is explicitly stated. Thus, the present disclosure is not limited to the examples shown, and any apparatus for performing the functions described herein is included in the aspects of the present disclosure.

It can be understood that “at least one” described in the present disclosure includes any and/or all possible combinations of the listed items, the various embodiments described in the present disclosure and the various examples in the embodiments may be varied and combined in any suitable form, and “/” described in the present disclosure represents “and/or.”

The text and drawings are provided as examples only to help readers understand the present disclosure. The text and drawings are not intended to limit and should not be interpreted as limiting the scope of the present disclosure in any way. Although certain embodiments and examples have been provided, based on the content disclosed herein, it is obvious to those skilled in the art that modifications to the illustrated embodiments and examples can be made without departing from the scope of the present disclosure.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a first node in a wireless communication system, the method comprising:
receiving a first message comprising low layer triggered mobility (LTM) failure report information related to a user equipment (UE); and
updating, based on the LTM failure report information and an LTM configuration related to mobility of the UE, an LTM configuration or a triggering strategy related to the mobility of the UE.

2. The method of claim 1, wherein:
the LTM failure report information comprises at least one of an LTM failure type, a cell global identifier (CGI) of a source cell, a CGI of a target cell, a CGI of a re-establishment cell, a CGI of a recovery cell, a cell radio network temporary identifier (C-RNTI) of the source cell, a C-RNTI of a target cell, a C-RNTI of a last serving cell, a UE radio link failure (RLF) report container, or a timing advance (TA) invalidation indication that are associated with the UE; or
the LTM failure report information associated with a secondary cell group (SCG) failure comprises at least one of the LTM failure type, a source primary secondary cell (PSCell) CGI, a CGI of a target PSCell, a CGI of a suitable PSCell, a C-RNTI of a source PSCell, a C-RNTI of a target PSCell, a C-RNTI of a last serving PSCell, an SCG failure report container, or the TA invalidation indication that are associated with the UE.

3. The method of claim 1, wherein the first message comprises at least one of an LTM failure report message, an LTM source primary secondary cell (PSCell) failure report message, an access and mobility indication (AAMI) message, or an Xn application protocol (Xnap) handover report message.

4. The method of claim 1, wherein the LTM configuration related to the mobility of the UE is included in the LTM failure report information, and wherein the LTM configuration comprises at least one of an LTM candidate cell list, an LTM candidate cell identifier (ID), an LTM source cell ID, an LTM channel state information (CSI) resource configuration, or an LTM CSI report configuration.

5. The method of claim 1, further comprising:
receiving a second message related to UE context release, the second message comprising an LTM configuration kept indicator; and
releasing an LTM configuration unrelated to the mobility of the UE and keeping, based on the second message, the LTM configuration related to the mobility of the UE,
wherein the LTM configuration related to the mobility of the UE comprises at least one of an LTM candidate cell list, an LTM candidate cell identifier (ID), an LTM source cell ID, an LTM channel state information (CSI) resource configuration, or an LTM CSI report configuration.

6. The method of claim 5, wherein the second message comprises at least one of an F1 application protocol (F1AP) UE context release command message, a UE context modification request message, or an Xnap UE context release message.

7. The method of claim 1, further comprising:
transmitting a message comprising the LTM configuration related to the mobility of the UE, the LTM configuration comprising at least one of an LTM candidate cell list, an LTM candidate cell identifier (ID), an LTM source cell ID, an LTM channel state information (CSI) resource configuration, or an LTM CSI report configuration,
wherein a previously transmitted LTM configuration is included in the received first message.

8. A method performed by a user equipment (UE) in a wireless communication system, the method comprising:
transmitting a message comprising radio link failure (RLF) report information used to generate low layer triggered mobility (LTM) failure report information related to mobility of the UE; and
executing an LTM procedure based on an LTM configuration updated using the LTM failure report information and an LTM configuration related to the mobility of the UE.

9. The method according to claim 8, wherein the RLF report information comprises at least one of the LTM configuration related to the mobility of the UE or LTM failure-related information,
wherein the LTM configuration comprises at least one of an LTM candidate cell list, an LTM candidate cell identifier (ID), an LTM source cell ID, an LTM channel state information (CSI) resource configuration, or an LTM CSI report configuration, and
wherein:
the LTM failure-related information comprises at least one of source cell information, target cell information, neighbor cell information, LTM candidate cell information, LTM cell information, last handover type information, information indicating a random access channel (rach)-based access failure or a rach-less access failure, or information on the rach-less access failure, or
wherein the LTM failure-related information associated with a secondary cell group (SCG) failure comprises at least one of an LTM failure type, source primary secondary cell (PSCell) information, target PSCell information, neighbor PSCell information, an LTM candidate PSCell list, an LTM PSCell identifier (ID), information indicating rach-based access failure or rach-less access failure, or information on the rach-less access failure.

10. The method of claim 8, wherein the LTM configuration related to the mobility of the UE is included in the LTM failure report information, and
wherein the LTM configuration comprises at least one of an LTM candidate cell list, an LTM candidate cell identifier (ID), an LTM source cell ID, an LTM channel state information (CSI) resource configuration, or an LTM CSI report configuration.

11. A method performed by a second node in a wireless communication system, the method comprising:
generating low layer triggered mobility (LTM) failure report information based on radio link failure (RLF) report information of a user equipment (UE); and
transmitting a first message comprising the LTM failure report information,
wherein the LTM failure report information and an LTM configuration related to mobility of the UE are used to update an LTM configuration or a triggering strategy related to the mobility of the UE.

12. The method according to claim 11, further comprising:
receiving, from the UE, a message comprising the RLF report information, the RLF report information comprising at least one of the LTM configuration related to the mobility of the UE or LTM failure-related information,
wherein the LTM configuration comprises at least one of an LTM candidate cell list, an LTM candidate cell identifier (ID), an LTM source cell ID, an LTM channel state information (CSI) resource configuration, or an LTM CSI report configuration, and
wherein:
the LTM failure-related information comprises at least one of source cell information, target cell information, neighbor cell information, LTM candidate cell information, LTM cell information, last handover type information, information indicating a random access channel (rach)-based access failure or a rach-less access failure, or information on the rach-less access failure; or
the LTM failure-related information associated with a secondary cell group (SCG) failure comprises at least one of an LTM failure type, source primary secondary cell (PSCell) information, target PSCell information, neighbor PSCell information, an LTM candidate PSCell list, an LTM PSCell identifier, information indicating rach-based access failure or rach-less access failure, or information on rach-less access failure.

13. The method of claim 11, wherein the LTM failure report information comprises the LTM configuration related to the mobility of the UE, and
wherein the LTM configuration comprises at least one of an LTM candidate cell list, an LTM candidate cell identifier (ID), an LTM source cell ID, an LTM channel state information (CSI) resource configuration, or an LTM CSI report configuration.

14. The method of claim 11, further comprising:
transmitting, to a first node, a second message related to UE context release, the second message comprising an LTM configuration kept indicator,
wherein the LTM configuration kept indicator is used to indicate that the first node keeps the LTM configuration related to the mobility of the UE while releasing an LTM configuration unrelated to the mobility of the UE, and
wherein the LTM configuration related to the mobility of the UE comprises at least one of an LTM candidate cell list, an LTM candidate cell identifier (ID), an LTM source cell ID, an LTM channel state information (CSI) resource configuration, or an LTM CSI report configuration.

15. The method of claim 11, further comprising:
receiving a message including the LTM configuration related to the mobility of the UE, the LTM configuration comprising at least one of an LTM candidate cell list, an LTM candidate cell identifier (ID), an LTM source cell ID, an LTM channel state information (CSI) resource configuration, or an LTM CSI report configuration,
wherein the LTM configuration is included in the first message.

16. The method of claim 15, wherein the message of the LTM configuration related to the mobility of the UE comprises a sequence number (SN) status transfer message.

17. A first node in a wireless communication system, the first node comprising:
a transceiver; and
a processor operably coupled to the transceiver, the processor configured to:
receive a first message comprising low layer triggered mobility (LTM) failure report information related to a user equipment (UE), and
update, based on the LTM failure report information and an LTM configuration related to mobility of the UE, an LTM configuration or a triggering strategy related to the mobility of the UE.

18. A user equipment (UE) in a wireless communication system, the UE comprising:
a transceiver; and
a processor operably coupled to the transceiver, the processor configured to:
transmit, a message comprising radio link failure (RLF) report information used to generate low layer triggered mobility (LTM) failure report information related to mobility of the UE, and
execute an LTM procedure based on an LTM configuration updated using the LTM failure report information and an LTM configuration related to the mobility of the UE.

19. A second node in a wireless communication system, the second node comprising:
a transceiver; and
a processor operably coupled to the transceiver, the processor configured to:
generate low layer triggered mobility (LTM) failure report information based on radio link failure (RLF) report information of a user equipment (UE), and
transmit a first message comprising the LTM failure report information,
wherein the LTM failure report information and an LTM configuration related to mobility of the UE are used to update an LTM configuration or a triggering strategy related to the mobility of the UE.
